(19) United States
(12) Patent Application Publication
(10) Pub. No.: US 2005/0094196 A1
(43) Pub. Date: May 5, 2005

(54) Setting of driving conditions corresponding to driving environments of peripherals

(76) Inventors: Masanori Saito, Nagano-ken (JP); Jyunichi Takenuki, Nagano-ken (JP); Hiraku Kanayama, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 10/917,238

(22) Filed: Aug. 11, 2004

(30) Foreign Application Priority Data
Aug. 11, 2003 (JP) 2003-291676

(51) Int. Cl. G06F 3/12; G06F 9/44; G06F 13/00

(52) U.S. Cl. 358/1.15; 710/8; 710/16; 719/321

(57) ABSTRACT

When extracting a settable range of working conditions of a peripheral connected to a computer, settable range data indicating the settable range of the working conditions, which settable range data includes working environment data specifying the working environment of the peripheral, is storable in a predetermined storage medium; in the event that settable range data including working environment data that matches the current working environment of the peripheral is not stored in the predetermined storage medium, a settable range is acquired via a driver or the like, and settable range data indicating the settable range is stored in a predetermined storage medium.

### BACKGROUND OF THE INVENTION

1. Field of the Invention

The present invention relates to a working condition acquisition device, a working condition acquisition method, a working condition acquisition program product, a UI control device, a UI control method, a UI control program product, a print control device, a print control method, and a print control program product.

2. Description of the Related Art

Ordinarily, a control program referred to as a driver is used in order to drive a computer peripheral, such as a printer. In the driver, working condition settings for driving the peripheral are handled, and the peripheral is driven in accordance with these settings. Typically, a UI (User Interface) is displayed on a display or the like, and working condition settings are made by the user through this UI.

### SUMMARY OF THE INVENTION

In the conventional art described above, a plurality of working conditions typically need to be set in order to drive a peripheral, and for interdependent working conditions, which have interdependency relationships among working conditions, changing one setting may cause the settable range for another to change. Additionally, settable range can vary with the working environment of a peripheral. Accordingly, there has been a wish to accurately ascertain settable ranges that vary with changes in working environment. In particular, there exists a need to accurately acquire settable ranges that vary with changes in working environment when displaying a UI which is the characteristic UI of application software.

With the foregoing in view, it is an object of present invention to provide a working condition acquisition device able to accurately acquire a settable range even in instances where the working environment of a peripheral has changed; a working condition acquisition method; a working condition acquisition program product; a UI control device; a UI control method; a UI control program product; a print control device; a print control method; and a print control program product.

In order to achieve the aforementioned object in the present invention, in an arrangement wherein settable range data is stored for each working environment of a peripheral, in the event that a specific working condition is a certain condition, a settable range settable with another working condition is acquired. In particular, where the working environment indicated by previously stored settable range data does not match the current working environment, or where settable range data is not stored, by creating settable range data that corresponds to the current working environment of the peripheral, a proper settable range can be assured, even where the working environment of the peripheral has changed. Thus, in the working condition acquirer, a settable range acquisition process is carried out when settable range data that contains working environment data matching the current working environment of the peripheral is not recorded in the settable range data storage medium. The settable range acquisition process is carried out by setting a specific working condition to a specific setting while referring to interdependency relationship data, and acquiring settable range for any other working condition dependent on the specific working condition.

Specifically, under a condition in which settable range will differ with a different working environment of a peripheral, settable range data corresponding to the current peripheral environment is created. Accordingly, it is possible to utilize correct settable range data when driving the peripheral. In particular, in an arrangement wherein working conditions for a peripheral are set using the characteristic UI belonging to application software rather than using the standard UI of the OS, i.e. the basic operating software of the computer, working conditions targeted for display may differ depending on an individual UI basis, and for working conditions that are interdependent, the setting for one may result in a change in settable range for the other. In the present invention, proper settable range data for each working environment is stored in a predetermined storage medium, whereby the proper settable range for the other working condition can be acquired easily.

While is possible in the above manner for settable ranges to be acquired in the working condition acquirer, the arrangement is such that in the working condition acquirer, once a working condition has been actually set for a peripheral the settable range for another working condition is acquired; in a favorable configuration example, the arrangement is such that the function of the driver etc. that drives the peripheral is utilized as the working condition acquirer. That is, a driver is a program that is executed by the program execution environment on a computer, and controls the working of a peripheral while setting various working conditions for it; there may occur conditions in which when a certain condition is set to a certain value in this driver, certain settings cannot be set for other working conditions.

It would be possible to acquire settable range by means of an arrangement enabling various kinds of instructions and queries to be made to a driver by means of a software interface, setting a certain working condition in the driver to a certain setting and determining whether in this state other settings are settable for other working conditions. That is, by means of an arrangement whereby with the driver for driving a peripheral installed on the computer, working condition settings and settable ranges for the driver can be acquired, it would be possible to readily acquire in the working condition acquirer a settable range, simply through a query of the settable range of a working condition required in accordance with an interdependency relationship identified from the interdependency relationship data.

To acquire a settable range in the working condition acquirer, it is necessary to carry out a processing operation to set a working condition for a peripheral and a processing operation that, once so set, requests settable ranges for other working conditions; where it is intended to acquire settable ranges for a plurality of working conditions, it will be necessary, having made repeated point-by-point settings, to repeatedly carry out an operation to acquire settable range, so that considerable processing time will be required. On the other hand, where settable range data is stored in a predetermined storage medium according to the present invention, it is possible to produce an arrangement whereby settable range can be acquired simply by referring to the settable range data stored in the predetermined storage medium, so that the settable range acquisition procedure can be carried out quickly. Therefore, in the present invention, there is employed an arrangement whereby settable ranges acquired by the working condition acquirer can be cumulatively stored as settable range data, whereby—particularly in conditions where settable range differs with different working environments of a peripheral—settable range data can be created in advance.

In the characteristic UI described above, working conditions for display on the UI may be selected appropriately for a particular purpose when controlling a peripheral. For example, where an application software is for the purpose of executing printing on a specific print medium such as postcards or checks, it will not be necessary to display a UI for the purpose of selecting print medium size as a working condition; or where an application software is for the purpose of printing high quality color images, it will not be necessary to display a UI for the purpose of selecting monochrome/color as a working condition. Of course, even where only the minimum necessary working condition items are displayed on a UI, an arrangement whereby other working conditions can be set as an option by a user who wants to make more advanced settings would be possible as well.

The aforementioned working conditions are conditions of various kinds needing to be set when driving a peripheral, and should be set by means of use selection or set automatically by the computer when driving the peripheral. Examples for a printer would be print resolution, type and size of print medium, and so on. For virtually all working conditions there is some latitude in selection, this latitude constituting the settable range. Working environment refers to the conditions in which a peripheral is placed, peripheral equipment, hardware, and so on, and should be objectively identified from the condition of the peripheral and/or computer prior to driving the peripheral.

In a plurality of working conditions, while complex interdependencies exist among working conditions, since these interdependency relationships are described in advance by interdependency relationship data, by referring to this interdependency relationship data it is possible to ascertain which working condition setting ranges change in the event of a change in the setting of a specific working condition, and to acquire settable ranges that include the dimension of complex interdependency relationships. Of course, in cases where interdependency relationships can change depending on the working environment of a peripheral, an arrangement whereby different sets of interdependency relationship data are created in advance for each working environment of the peripheral and working environment data is included in the interdependency relationship data, with the working condition acquirer referring to interdependency relationship data the includes working environment data matching the current working environment, would also be acceptable.

Here, a peripheral may be any device connectable to and drivable by a computer; various kinds of devices fall into the class of such peripherals. For example, an output device such as a printer, display or projector connected to a computer to carry out image output operations, an input device such as a scanner or digital camera connected to a computer to carry out image input operations, a recording device such as a hard disk drive connected to a computer to carry out data recording operations, or various other devices could serve as peripherals. Also, various devices may make up a computer. That is, any computer that controls a peripheral is acceptable; besides general purpose computers, the computer of the invention could be a computer for executing various functions such as those of a digital camera, cell phone, or the like.

In interdependency relationship data it is sufficient to be able to identify working conditions that exist in an interdependency relationship in the event that a difference in the setting of a specific working condition is associated with a change in the range of settable settings for another working condition. That is, by ascertaining interdependency relationships among working conditions by means of interdependency relationship data, it is possible to acquire settable ranges for interdependent working conditions, while avoiding execution of processes for acquiring settable ranges for working conditions which are not interdependent, so that settable range data can be created with the minimum processing needed.

It is sufficient for settable range data to be data that can be utilized when displaying a UI for setting working conditions for a peripheral, and to be able to indicate settable value ranges for working conditions. Of course, where an interdependency relationship exists between a specific working condition and another working condition, settable range data will be composed of data specifying a setting for the specific working condition and a settable range for the other working condition at that setting. Here, working condition settings merely need to be values that correspond with conditions, and are not limited to numerical values. That is, cases in which working conditions are specified by text strings are includes as well. However, an arrangement wherein numerical values are associated with conditions in a device handled by a computer, and working conditions are designated by numerical values, is preferred. For data in which settable ranges are indicated by text strings, when displaying working condition decision branches on a UI, it is possible for the text strings on the UI to change with change in settable ranges.

The settable range data storage medium need simply to be able to store settable range data; it is not essential that settable range data be already stored therein. That is, where settable range data is not already stored, a settable range can be acquired where settable range data that includes working environment data matching the current working environment has not been stored. Of course, where already stored, it is sufficient to determine whether the working environment data of the previously stored settable range data matches the current working environment of the peripheral.

Working environment data need simply identify the working environment of a peripheral; the working environment may describe data indicating conditions in which a peripheral is placed, peripheral equipment, hardware, and so on, as part of the settable range data. For example, data indicating the model of a peripheral by way of peripheral equipment can be employed as working environment data. That is, where the model of a peripheral differs, interdependency relationships and settable ranges for working conditions therefor can differ as well, so by describing working environment data indicating the model of the peripheral in the settable range data, it becomes possible to create settable range data on a model-by-model basis in the working condition acquirer.

Examples of conditions in which a peripheral is placed are whether there is an update of the working condition acquirer, locale information on the computer, and so on. That is, as noted the working condition acquirer may be composed of a driver or the like, and sometimes a driver is given improved functionality or is debugged through a version upgrade. Interdependency relationships and settable ranges for working conditions can change with such a version upgrade. Accordingly, data indicating whether there is an update of the working condition acquirer, for example, data indicating driver version, can be employed as working environment data. As a result, it is possible to create settable range data on a driver-by-driver basis in the working condition acquirer.

Data indicating locale on a computer is used as working environment data in consideration of the fact that settable range data is utilized by the computer. That is, locale information is information that indicates the country, language etc. in which the computer is used; where locale information differs, text strings displayed on the UI will differ as well. Accordingly, by using locale information as working condition data, it becomes possible to create settable range data that differs when locale information differs. As a result, it becomes possible, in the event that the standard language used on a computer is changed, to create settable range data corresponding to that language so that appropriate settable range data corresponding to that language can be referred to on the UI.

An example of data indicating peripheral equipment or hardware is data indicating a component of a peripheral. That is, interdependency relationships and settable ranges can change with a change in the components that make up a peripheral, for example, in the case of a printer, a change in ink or installation of a cutter or other attachment; or in the case of a scanner, replacement of the light source component or installation/removal of a transparent original scan unit. Accordingly, by employing data indicating components of a peripheral as working environment data, it becomes possible, in the event of different components of a peripheral, for the working condition acquirer to create different settable range data for each component.

As described hereinabove, it is sufficient to determine in the working condition acquirer whether there is stored in the settable range data storage medium settable range data that includes working environment data matching the current working environment of a peripheral. As an example of an arrangement for acquiring the current working environment of a peripheral in order to make this determination, there could be employed an arrangement comprising a working environment handling portion for handling specification of a peripheral working environment, and when handling this specification deciding the current working environment of the peripheral.

That is, when a peripheral is connected to a computer to enable it to be used, in many instances, in order to drive the peripheral the user will specify in advance from the UI some or all the working environment, e.g. the model of the peripheral. In an arrangement wherein the working environment of the peripheral is specified from the UI prior to driving it, the working environment of the peripheral is confirmed at the time of this specification and the peripheral is then driven according to this working environment; thus, by acquiring working environment according this timing, it becomes possible to acquire the current working environment and actual working environment driving the peripheral.

In the working environment handler that specifies the working environment, it is possible to handle the working environment specified as the default, or to handle a working environment specified by the user. More specifically, this would correspond to a case wherein a plurality of peripherals such as a printer and scanner are connected to a computer and wherein it is possible, when using the printer or scanner, to specify from the UI working conditions thereof as well as to specify the model of printer or scanner to be driven. By ascertaining the current working environment when handling specification for a working environment in this way, it becomes possible to determine whether the specification matches the current working environment or whether a working environment according to this specification can be implemented, and if it already matches or cannot be implemented, to issue an error message or the like.

As yet another exemplary arrangement for deciding the current working environment of a peripheral, it would be possible to determine the current working environment of the peripheral at predetermined timing when the computer is booted up. That is, according to this arrangement, even where the user has not explicitly changed the working environment from the UI etc. after modifying the working environment, it is nevertheless possible to decide the current working environment. As the predetermined timing, any timing determined in advanced would be acceptable, it being possible to employ various kinds of timing schemes such as periodic timing, or timing when the UI for driving the peripheral is first displayed.

When determining a working environment, it is sufficient to be able to compare the aforementioned working environment data with the current working environment, various arrangements being possible for determining working environment. For example, an arrangement whereby communication with the peripheral is enabled and data indicating the model of the peripheral and the components of the peripheral is acquired through said communication would be acceptable. With such an arrangement, it is possible to determine current working environment even if the user does not explicitly indicate that a component of the peripheral has been replaced. In an arrangement for referring to settable range data when displaying the UI in the above manner, even if the user does not explicitly specify replacement of a component of the peripheral, such as the ink set for example, it will nevertheless be possible to present in the UI a settable range that reflects the ink set.

Of course, since a driver like that described above is used in a computer in order to drive a peripheral, and the driver corresponds to the model of the peripheral, it would be possible as well to employ an arrangement whereby data indicating model name is stored as data for use by the driver, and in response to a request for model name, reference is made to this data to reply with the model name. In a similar arrangement, an arrangement for replying with the driver version would be acceptable as well. That is, an arrangement whereby data indicating driver version is stored, and reference is made to this data in response to a request. Furthermore, since the aforementioned locale information typically consists of OS settings, it would be possible to acquire the locale information by means of an arrangement whereby reference is made to OS settings or to locale information stored by the OS in a predetermined storage medium.

Furthermore, in a preferred exemplary arrangement of the invention, there may be employed arrangement wherein when storing settable range data in a predetermined storage medium, stored settable range data is retained without being updated. Specifically, in the present invention, when existing working environment data does not match the current working environment, or when there is no settable range data for working environment data matching the current working environment, settable range data that matches the current working environment is created; however, in some instances the working environment may revert to a preceding one. Thus, by retaining existing settable range data without deleting it, it becomes possible, in the event that the working environment reverts to a preceding one, to use preceding settable range data without having to recreate settable range data.

In this way, the method for creating settable range data depending on current working environment is not necessarily limited to a physical device, a method invention being effective as well. The devices described above may in some instances exist independently, or be utilized in a form incorporated into a certain machine. Various embodiments are included within the inventive idea. Modifications, such as the choice between a software or hardware arrangement, may be made as appropriate.

Where, as a specific example, the inventive idea is embodied as software for a working condition acquisition device, the software will also correspond to the invention. As one example thereof, the invention may be designated as a working condition acquisition program product. Of course, the storage medium therefor may consist of a magnetic storage medium or a magnetooptical storage medium; any storage medium developed in the future could be considered completely analogously. Any reproduction stage, whether it be a primary reproduction, secondary reproduction, or the like, is also equivalent without any doubt whatsoever.

Further, an invention wherein settable range data is created depending on current working environment, and a UI is displayed by referring to this settable range data is also acceptable. Where a printer is used as a peripheral, in an arrangement whereby printing conditions are set as the working conditions by the UI to execute printing, settable range data can be created with reference to interdependency relationship data.

### BRIEF DESCRIPTION OF THE DRAWINGS

FIG. 1 is a block diagram showing a simplified arrangement of a print control device.

FIG. 2 is an illustration showing a printer DB data description example.

FIG. 3 is an illustration showing a resource DB data description example.

FIG. 4 is an illustration showing settable range together with interdependency relationships.

FIG. 5 is a flowchart of a print control process.

FIG. 6 shows an example of a UI display.

FIG. 7 is a flowchart of resource DB building process.

FIG. 8 is a flowchart of resource DB building process.

FIG. 9 is a flowchart of resource DB building process.

FIG. 10 is an illustration describing an example of processing when building a resource DB.

### DETAILED DESCRIPTION

The following description of the embodiments of the invention will be made according to the order indicated below.
(1) Arrangement of the Invention:
   (1-1) Arrangement of UI Control Module:
(2) Arrangement of Printer DB:
(3) Arrangement of Resource DB:
(4) Print Control Process and UI Display Example:
(5) Resource DB Building Process:
(6) Other Embodiments:

(1) Arrangement of the Invention:

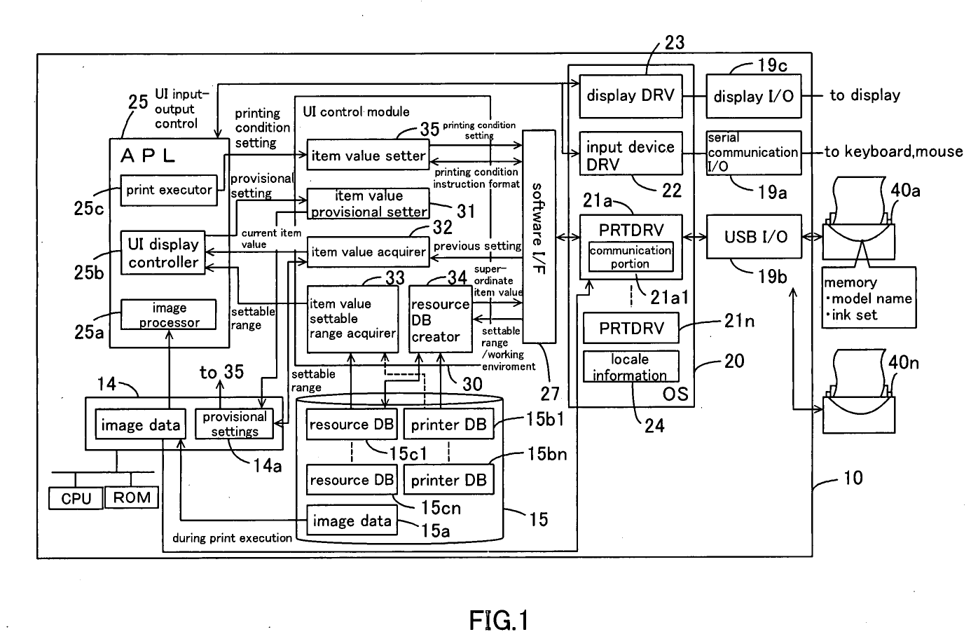

FIG. 1 is a block diagram showing a simplified arrangement of a computer employed as a print controller pertaining to the invention. Computer 10 comprises a CPU serving as the center of operations and ROM, RAM 14 or the like serving as storage media, the computer being able to execute a predetermined program while utilizing a peripheral such as an HDD 15. Operating input devices such as a keyboard and mouse are connected to the computer 10 via a serial communications I/O 19a, and a display for image display is connected via a display I/O 19c. A printer 40 is connected via a USB I/O 19b. In FIG. 1, a multiplicity of printers 40a-40n (Here, “n” appended to a symbol indicates that any plural number may be used.) are shown connected to computer 10.

Printer 40 in this embodiment comprises a mechanism having a detachable ink cartridge for each color, these being filled with inks of several colors. The mechanism can accommodate cartridges of CMYKIcImG (cyan, magenta, yellow, black, light cyan, light magenta, gray) inks. The printer 40 in this embodiment can also use two kinds of K ink as K ink, namely, photo black for use on glossy paper and plain paper, and matte black with preference to image quality on matte paper.

In printer 40, either kind of K ink may be used, and instead of G ink, it would be possible to install and use two matte black ink cartridges. G ink is ink consisting of black coloring matter in a solvent, but since the concentration of the coloring matter is lower than that of black ink, by using G ink, it is possible to reproduce tone changes with a high degree of accuracy. Also, in a printer 40, inks may be combined to produce a multitude of colors, and to thereby form an image on a print medium.

Of course, the ink colors useable in printer 40 are only exemplary, it being possible instead to use dark yellow ink, or to use red ink or violet ink, or to use achromatic ink to adjust glossy appearance. Nor is the number of colors limited to seven, nor are the color combinations limited to the combinations mentioned above. The printer 40 in this embodiment is a printer of so-called ink jet format, wherein force is exerted on inks contained within an ink head filled with the inks, to eject the inks. Here, ejecting force may be exerted on the ink by applying voltage to a piezo element, or ejecting force may be exerted on the ink by forming bubbles within the head. The invention is also applicable to printers of various other types besides ink jet format, such as laser format.

To describe the computer 10 in a somewhat simplified manner, one having a configuration typical for a personal computer may be used. Of course, the invention is not limited to implementation in a personal computer. Nor is there any need to limit the interface connecting the computer 10 and printer 40 to that described above, it being possible to employ various other connection configurations, such as a parallel interface or SCSI connection, wireless link, or any other connection configuration that may be developed in the future.

Further, while in this embodiment the print controller is composed of a computer 10, the print controller of the invention could instead be reduced to practice by means of a program execution environment installed in printer 40, with image data being acquired from a digital camera connected directly to printer 40, which carries out the print control process. The UI may be displayed on a small LCD panel on printer 40, or on an LCD panel provided to the digital camera. Of course, in a similar arrangement the print control process could be carried out by the digital camera; the print control process pertaining to the invention could be carried out by distributed processing; the UI could be displayed on the screen of a cell phone, and the print control process carried out by means of a program execution environment loaded on the cell phone or printer; or various other arrangements would be possible as well. That is, any embodiment wherein the computer displaying the UI and carrying out print control us able to executed a predetermined program by means of a CPU, RAM, and ROM etc. would be acceptable. The print control process pertaining to the invention could also be carried out by a so-called multifunction device that combines in a single unit a scanner for scanning images and a printer for printing images.

In the computer 10 pertaining to this embodiment, the OS 20 incorporates a printer driver (PRTDRV) 21, an input device driver (DRV) 22, and a display driver (DRV) 23. Display DRV 23 is a driver for controlling display of image data and the like on a display; input device DRV 22 is a driver for receiving a code signal from the aforementioned keyboard or mouse via the serial communications I/O 19a and handling a predetermined input operation.

APL 25 is an application program able to execute color image retouching or the like; a user, by operating an aforementioned operation input device under execution of APL 25, can print a color image from printer 40. That is, in response to a user instruction the image processor 25a of APL 25 reads into to RAM 14 image data 15a stored on HDD 15, and via the display DRV 23 displays on the display an image based on the image data 15a. When the user operates the aforementioned input device, the content of the operation is acquired via input device DRV 22 and the content interpreted, whereupon the image processor 25a carries out image processing, such as contrast adjustment, depending on the control content.

The aforementioned image data 15a is data of dot matrix form wherein the RGB (red, green, blue) color components are tone represented to specify color of each pixel; in this embodiment, there are 256 tones for each color, the image data employing a color system in accordance with the sRGB standard. While this color data 15a is used as an example in this embodiment, various other kinds of data could be employed, such as JPEG image data using the YCbCr color system, image data using the CMYK color system, or the like. Of course, the invention could also be implemented for data based on the Exif 2.2 standard (Exif is a registered trademark of the Japan Electronics and Information Technology Industries Association) or data in accordance with Print Image Matching (PIM; registered trademark of Seiko-Epson Corp.).

In APL 25, it is possible to execute printing from printer 40 of an image or the like subsequent to image processing in image processor 25a; during printing, a UI enabling printing condition items settings to be made is displayed to the user, and printing is executed according to instructions made from the UI. Thus, APL 25 comprises a UI display controller 25b and a print executor 25c, with data for displaying a UI for setting printing condition items being output to display DRV 23 by UI display controller 25b. Data indicating settable ranges for and interdependencies among printing condition items to be displayed on the UI, which data matches the current working environment of the printer, is acquired from the UI control module 30.

Printing condition items are items for a plurality of conditions required in order to execute printing, and include various printing condition items settable in PRTDRV 21, such as print resolution, ink type (color/monochrome selection or ink set (ink color combination) selection), print medium type and size, layout during printing, borderless printing enabled/disabled, print quality (high quality vs. high speed, etc.), type of color management (auto-adjust enabled/disabled, use of colors outside the display gamut enabled/disabled, etc.), bidirectional printing enabled/disabled, image processing by driver enabled/disabled, and the like. In this embodiment, print conditions such as print resolution, ink type and the other items mentioned above are set on an item-by-item basis, so different print conditions can be distinguished by way of items. Also, the particulars of each print condition setting are specified by a numeric value (setting) corresponding to the particulars thereof, and these numeric values are referred to as item values.

UI display controller 25b displays the aforementioned UI on the display, acquires via the aforementioned input device DRV 22 the content of a control input performed by the user, and acquires item values for printing condition items specified by the control input. The item values acquired her as held as provisional settings. Item values of printing condition items at the time of execution of the previous print job are held in a predetermined storage medium, with these item values being displayed on the UI. Accordingly, the previous item value settings are preserved for printing condition items that are not set the user.

In certain instances settable item values for a printing condition item will be dependent on the item value of another printing condition item; in such instances, setting a certain item value may produce a change in the range of values settable for another printing condition item. Additionally, interdependency relationships and settable item value ranges change depending on the working environment of the printer when executing printing. In this embodiment, the UI display controller 25b acquires from the UI control module 30 data indicating settable ranges and interdependency relationships among item values that match current working conditions as described above, and referring to this data updates the UI display for other printing condition items whose settable ranges are affected by setting of a certain item value. As a result, settable ranges displayed on the UI will be the appropriate ranges corresponding to settings of other printing condition items and to current working conditions.

In the UI pertaining to this embodiment, as will be described later, there employed an arrangement whereby a small number of printing condition items are displayed on a single screen, and once input has been made for those items, the screen is switched to display other printing condition items. Accordingly, selectable ranges shown on the UI will differ between the case where one proceeds to the next screen after setting a certain printing condition item from a first screen, and the case where one proceeds to the next screen after setting another printing condition item from the first screen. Where a settable range no longer exists depending on the item value of a printing condition item or on the current working environment, a UI for setting that printing condition item will not be displayed. Accordingly, in this embodiment wherein printing condition items are displayed while switching between screens, there will be some UI screens that are displayed in certain working environments but not displayed in other working environments.

Of course, where interdependency relationships exist among a plurality of printing condition items displayed on a single screen, the setting of a certain printing condition item or the working environment can cause the settable range for another printing condition item to vary, so in such a case, item values for non-selectable printing condition items will not be displayed as decision branches, while item values for selectable printing condition items will be displayed as decision branches. Similarly, for a large number of printing condition items displayed on a single screen, in the event that setting of a certain printing condition item has caused the settable range for another printing condition item to vary, item values for non-selectable printing condition items will not be displayed as decision branches, while item values for selectable printing condition items will be displayed as decision branches.

In the UI display controller 25b there are used default item values for printing condition items not shown in the UI, which are stored in a predetermined storage medium so that, of the extremely large number of printing condition items, only those printing condition items needed for printing by the APL 25 are displayed on the UI. For example, where the APL is specialized for postcard printing, since there is no need to select any printing paper setting other than postcard size, it would be possible to employ an arrangement whereby print medium size is fixed at postcard size by way of a printing condition item. By means of such an arrangement, the designer of the APL can decide in advance which printing condition items will be displayed on the UI, making it possible to provide an interface that does not display a more complicated UI than necessary and is easier for the user to understand.

In this UI, it is possible to carry out a print execute instruction, and when UI display controller 25b detects the print execute instruction on the basis of the content of an operation performed on the UI, a process carried out by print executor 25c commences. As printing conditions in PRTDRV 21, the print executor 25c sets up item values of printing condition items held as provisional settings in the manner described above and transfers the image data targeted for printing to PRTDRV 21. PRTDRV 21 further comprises modules, not shown, for performing resolution conversion, color conversion, halftone processing, and other processes; these modules generate print data by carrying out, on print target data targeted for printing, processes depending on item values of printing condition items. The print data so generated is then output to printer 40 via USB I/O 19b, whereupon printer 40 executes printing on the basis of the print data. PRTDRV 21 is a dedicated module for each printer 40a-40n; in FIG. 1, PRTDRV 21a-21n are shown installed for each model.

(1-1) Arrangement of UI Control Module:

The aforementioned UI control module 30 administers a process of transferring to the aforementioned UI display controller 25b appropriate data indicating item values for printing condition items and settable range and interdependency relationships for printing condition items needed for UI display; in this embodiment, by means of this module, rapid change of display in response to a change in a item value of a printing condition item having complex interdependency relationships is possible. Also, a settable range corresponding correctly to the current working environment is displayed. Thus, the UI control module 30 comprises an item value provisional setter 31, an item value acquirer 32, an item value settable range acquirer 33, a resource DB creator 34, and an item value setter 35.

In order to be able to rapidly acquire printing condition item settable ranges and interdependency relationships for each working environment in UI display controller 25b, the UI control module 30 is arranged so that item values of printing condition items selected on the UI are held as provisional settings, and reference is made to databases created in advance for each working environment, returning the UI display controller 25b settable ranges and interdependency relationships when these provisional settings have been made. Thus, printer DB 15b1-15n and resource DB 15c1-15cn are recorded on HDD 15, at least prior to commencing UI control. Here, printer DB 15b1-15n are databases corresponding to the models of printers 40a-40n; resource DB 15c1-15cn are databases corresponding to the models of printers 40a-40n.

In this embodiment, printer DB 15b1-15n are databases describing interdependency relationships among printing condition items, and are installed at the time that PRTDRV 21 is installed on HDD 15. In resource DB 15c1-15cn are recorded superordinate items for printing condition items, and printing condition items at each item value of these superordinate items. Accordingly, when a change has occurred in the item value of a certain printing condition item, there can be acquired the item values assumable by a printing condition item having this item as a superordinate item, so that it can be said that a settable range is acquired. That is, the resource DB makes up settable range data. Where a printing condition item and another printing condition item are related to one another such that once the item value of a first item is determined, a settable range is determined for item values of the second printing condition item, the superordinate item would be the first item.

Further, since interdependency relationships and settable ranges for printing conditions can differ by printer model, in this embodiment, printer DB 15b1-15n and resource DB 15c1-15cn are used on a printer-by-printer basis, so as to be able to refer to interdependency relationship data and settable range data on an individual printer model basis. In this embodiment, it is possible to refer to information indicating PRTDRV 21a-21n version and ink set as information identifying the working environment, so for a given printer, different resource DB are created if there are different PRTDRV 21a-21n versions, and different resource DB are created if there are different ink sets, these being stored in advance in HDD 15.

The resource DB creator 34 of UI control module 30 is responsible for creation of resource DB; it utilizes the software I/F 27 to refer to the aforementioned printer DB 15b1-15bn and create resource DB 15c1-15cn. That is, software I/F 27 has an arrangement that enables exchange of data with PRTDRV 21 to be able to acquire item values, acquire settable ranges, set item values, and acquire current working environment; resource DB creator 34 acquires settable ranges for item values having interdependency relationships, while setting items value via software I/F 27. Accordingly, PRTDRV 21 and resource DB creator 34 constitute the aforementioned working condition acquirer.

As described hereinabove, printing conditions exist in interdependent relationships, and with the superordinate item value for the specific printing condition item held constant there can be acquired by means of software I/F 27 a settable range for a specific printing condition item. Accordingly, by repeating the process of setting a value and acquiring a settable range, for all item values assumable by a superordinate item, it is possible to acquire settable ranges and interdependency relationships for specific printing condition items. Of course, there is no need for a repeat procedure for printing condition items having no interdependency.

In this software I/F 27, while a predetermined processing time is required, it is possible thereby to acquire settable range by means of the aforementioned repeat procedure. Thus, data indicating interdependency relationships and settable ranges can be created as resource DB 15c1-15cn. Of course, settable ranges can be created in resource DB 15c1-15cn for printing condition items lacking the aforementioned interdependency relationships as well.

In this embodiment, when creating a resource DB, a determination is made as to whether there is recorded on HDD 15 a resource DB containing working environment data that matches the current working environment. That is, prior to the UI display controller 25b displaying the UI, a resource DB indicating settable range data in the current working environment is recorded on HDD 15, so that the resource DB creator 34 acquires data indicating the current working environment. Thus, PRTDRV 21a-21n comprise communication portions (in FIG. 1, only the communication portion 21a1 for PRTDRV 21a is shown), and printers 40a-40n each store in memory data indicating their own model name and ink set.

The aforementioned communication portion 21a1 etc. communicate with printers via a USB I/O 19b to acquire data indicating printer model name and ink set. Software I/F 27 enables requests to be made to PRTDRV 21a-21n and acquisition of data indicating printer model name and ink set and PRTDRV 21a-21n version acquired by said communication portions. Via software I/F 27 the resource DB creator 34 acquires data indicating printer model name and ink set and PRTDRV 21a-21n version. This data corresponds to data indicating the working environment at the point in time that that data was acquired, i.e. to the current working condition.

In the resource DB 15c1-15cn is described working environment data indicating the working environment to which settable ranges described in the respective resource DB 15c1-15cn should be applied. Accordingly, the resource DB creator 34 refers to resource DB that have finished being recorded on HDD 15, and compare them with the aforementioned data indicating current working environment in order to determine whether there is recorded on HDD 15 a resource DB containing working environment data that matches the current working environment. At this time, if it is determined that there is recorded on HDD 15 a resource DB containing working environment data that matches the current working environment, in resource DB creator 34 there will not be carried out an operation to create a resource DB; or if not determined to be recorded, in resource DB creator 34 there will be carried out an operation to create a resource DB.

As a result, in this embodiment, when a printer model is used for printing for the first time, a resource DB corresponding to the particular model is created. Additionally, after a version update of PRTDRV 21a-21n, when a printer is first controlled by the driver, a resource DB corresponding to the particular driver is created. Further, when the ink set used in a printer 40 has been modified, when printing is first executed with the modified inks, a resource DB corresponding to the particular ink set is created. Additionally, in the event that an optional component used by a printer 40 has been modified, for example, where there has been a change in whether an automatic printer paper cutter is used, a resource DB describing a working environment that corresponds to the condition of use thereof will be created. Once created, it is held in HDD 15. Accordingly, duplicative versions of a given resource DB will not be created. Creation of resource DB 15c1-15cn and contents of these databases will be described in detail later.

When UI display controller 25b creates a UI, the item value settable range acquirer 33 refers to resource DB 15c1-15cn or to printer DB 15b1-15bn and transfers to UI display controller 25b data indicating settable ranges for printing condition items targeted for display. Item value acquirer 32 acquires the current item values for the printing condition items. Accordingly, UI display controller 25b can display the aforementioned settable ranges for the printing condition items as decision branches, as well as producing and displaying a UI showing current item values selected as defaults.

Here, current item values are item values at the point in time that item value acquirer 32 carries out the process; in the initial phase of displaying a UI for printing an image, item values for printing condition items at the time of the previous print job was executed are acquired by item value acquirer 32. The previous item values acquired by the item value acquirer 32 are transferred as current item values to the UI display controller 25b, and are recorded as provisional settings 14a in RAM 14.

In the event that an item value has been modified even once on the UI between the time that the UI is displayed and the time that printing is executed, the item value acquirer 32 will not acquire item values via software I/F 27, but will rather use the item values indicated by the provisional settings 14a as the current item values for output to the UI display controller 25b. Accordingly, when the UI is displayed by the UI display controller 25b, there will be no need to execute reception of data with PRTDRV 21 via software I/F 27, so that current item values can be acquired faster.

When a change of an item value is handled by the aforementioned UI display controller 25b, the item value provisional setter 31 will acquire that item value as a provisional setting, and will record it as a provisional setting 14a in RAM 14 without setting the provisional setting for PRTDRV 21 via software I/F 27. Accordingly, for a item value changed on the UI, the provisional setting 14a in RAM 14 will be updated, but at this stage the item value for PRTDRV 21 will not be updated.

Once a provisional setting 14a has been updated, where the provisional setting 14a is then acquired by the aforementioned item value acquirer 32 and a settable range is acquired by the item value settable range acquirer 33, there can be displayed a UI in which settable range has been updated appropriately depending on the update of the item value in UI display controller 25b. That is, even where the settable range for a certain interdependent item changes due to a item value being updated, the item value settable range acquirer 33 can refer on a case-by-case basis to the resource DB 15c1-15cn in order to determine the correct settable range. Of course, here, since reference is made to the resource DB corresponding to the current working environment, a selectable range appropriate for the current working environment can be displayed as decision branches on the UI. Updating of the UI display will be described in detail later.

Printing condition item settings made from the UI are held as provisional settings 14a, and are not actually set for PRTDRV 21; however, where the item value of a printing condition item has been determined by the user by means of the UI, and a print execute instruction issued, the item value setter 35 performs setting of the item value via the software I/F 27. The item value setter 35 is able to interpret the data format for specifying printing conditions of PRTDRV 21 via software I/F 27, as well as setting the item value of each printing condition item for PRTDRV 21 while conforming to this data format.

Specifically, making reference to provisional settings 14a in RAM 14, it creates data of the aforementioned format such that the item values of the printing condition item assumes the value indicated by the provisional settings 14a. When the data is then transferred to software I/F 27, the item value of the printing condition item is set in PRTDRV 21 in the manner described in the data. As regards the arrangement for setting printing conditions with data of predetermined format via software I/F 27, since the arrangement for specifying printing conditions differs by OS, the arrangement will be one that compensates for this so that data processing for UI display can be carried out without any awareness of differences due to the OS, at least in APL 25.

That is, in each OS there is typically provided a function for setting item values for printing condition items for PRTDRV 21, but the method of setting printing conditions differs by OS. Accordingly, in the present embodiment, there is employed an arrangement whereby UI display is rapidly controllable by UI control module 30 by means of a method that is not OS-dependent; during actual execution of printing, printing conditions are set while distinguishing the printing condition setting method in the item value setter 35. As a result, the designer of the application providing the APL 25 and UI for same during printing can specify item values for printing condition items using a common method and create programs for controlling PRTDRV 21, without having to be aware of differences among OS.

In the present invention, settable ranges corresponding to the current working environment are appropriately displayed, and in the sent of providing the UI intended by the creator of the APL, it is sufficient to provide resource DB 15c1-15cn, item value provisional setter 31, item value acquirer 32, and item value settable range acquirer 33; an arrangement whereby differences among OS are compensated for the software I/F 27 is not essential. For example, rather than making item value settings for printing condition items via software I/F 27, there could be employed an arrangement whereby item value settings for printing condition items are made directly for each PRTDRV 21 by the UI control module 30.

(2) Arrangement of Printer DB:

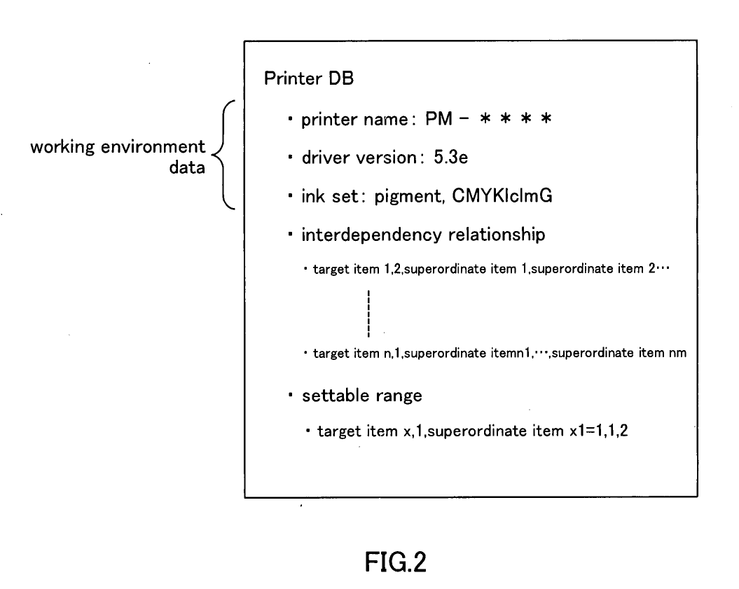

Next, the arrangement of printer DB 15b1-15bn in the embodiment will be described in detail. FIG. 2 is an illustration showing a printer DB 15b1-15bn data description example. As shown in the drawing, printer DB 15b1-15bn describe data indicating printer name, driver version, ink set and interdependency relationships. The printer name is data indicating the model name of printer 40 (in FIG. 2, “PM-****”). Since as part of the working environment printing condition items and interdependency relationships are model-dependent, in this embodiment, it is described which printer DB 15b1-15bn is used for which model of printer. Where a plurality of printers are connected to computer 10 with a plurality of PRTDRV being installed for printers so that a plurality of printers may be used, this description is used in order to identify the printer for which a printer DB has been described.

Driver version is data identifying the version of the printer driver (in FIG. 2, version 5.3e). A new version of a printer driver may in some instances add new functionality, the aforementioned interdependency relationships may change, and error correction and the like may differ among versions, so in this embodiment the driver version that printer DB 15b1-15bn is used for is described. In the event that the user of computer 10 procures and installs a version upgrade of PRTDRV 21, this description will be used to identify the driver version for which the printer DB should be used. As will be described later, even if resource DB 15c1-15cn has been recorded onto HDD 15, if a resource DB 15c for use with the driver version described in printer DB 15b1-15bn has not been recorded on HDD 15, the resource DB 15c will be rebuilt, so that even if new functions are added, or interdependency relationships change with a change in driver version, interdependency relationships after the change can be accommodated.

Ink set is data that uniquely specifies the combination and types of ink cartridges installed on a printer 40 (in FIG. 2, a CMYKlclmG ink set composed of pigment based inks). Depending on the combination of ink colors used, color management and image processing enablement/disablement may differ and the aforementioned interdependency relationships may vary, so in this embodiment, a printer DB 15b1-15bn is described in terms of which ink set it is used for. In the event that the user of computer 10 has modified the combination of ink colors installed in a printer 40, this description will be used to identify which printer DB should be used for which ink set. In this embodiment, if a resource DB 15c1-15cn for an ink set corresponding to current working conditions is not recorded on HDD 15, resource DB 15c1-15cn will be rebuilt so as to correspond with interdependency relationships after a modification of the ink set.

Interdependency relationships are specified by means of associating target printing condition items (target items) that specify interdependency relationships with superordinate items thereof, while cataloging them. In this embodiment, interdependency relationships are specified by means of describing, in order, data indicating “target item n, superordinate item number m, superordinate item n1 . . . superordinate item nm.” Here, n and m are zero or natural numbers, with m superordinate items being dependent on each of the n target items, and the superordinate items being cataloged. For target items for which no superordinate item exists, m is 0 and no superordinate item is described. For target items and superordinate items, it is sufficient to be able to identify the target item per se; for example, where the target item is print quality and the superordinate item is type of print medium, with superordinate items numbering one, the description would be “print quality, 1, print medium type.

In this embodiment, printer DB 15b1-15bn is referred to in order to create resource DB 15c-15cn, and thus for this purpose it is acceptable for it to describe the aforementioned working environment data and data indicating interdependency relationships; in this embodiment, settable ranges are described in order to further enhance convenience. A settable range is shown at bottom in FIG. 2, in a format that describes, in order, data indicating “target item x, superordinate item number 1, superordinate item x1 and value thereof . . . superordinate item x1 and value thereof, settable range.”

That is, whereas the fact of describing interdependency relationships for a given target item x by means of describing the number of superordinate items and subordinate items is an element in common with the interdependency relationship format described previously, in the format for settable range, item values of superordinate items are identified, and a target item value when a superordinate item is finally that item value is described. By so doing, it is possible to specify a settable range for a target item when an item value in a superordinate interdependency relationship is a specific value. This format is in common with the settable range format described in resource DB 15c1-15cn, described later. Resource DB 15c1-15cn are created by means of interdependency relationships described in printer DB 15b1-15bn, but in some instances, an error or the like occurring in PRTDRV 21 during creation thereof may result in an inability to properly acquire a settable range, in which instance an appropriate settable range cannot be described in resource DB 15c1-15cn.

Accordingly, after creating PRTDRV 21 an appropriate settable range is described in printer DB 15b1-15bn, and during creation of resource DB 15c1-15cn by the aforementioned resource DB creator 34, first, reference is made to the printer DB 15b1-15bn, and when a settable range is described in a printer DB 15b, the content of the description in the printer DB 15b1-15bn is acquired. By means of this arrangement, even if it should not be possible to properly acquire a settable range due to an error or the like occurring in PRTDRV 21, it will nevertheless be possible to readily transfer an appropriate settable range to the item value settable range acquirer 33. In the event that registering all settable ranges for all items in resource DB 15c1-15cn will take an extremely long time, an arrangement whereby only some settable range data is described in resource DB 15c1-15cn would be possible. In such an arrangement, when performing UI display, since settable range data is not described in the resource DB 15c1-15cn, settable range data will be acquired by referring to the printer DB 15b1-15bn.

(3) Arrangement of Resource DB:

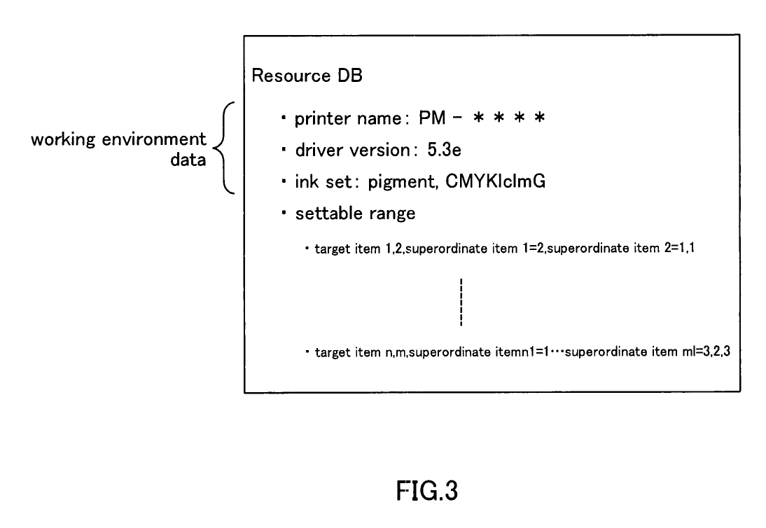

Next, the arrangement of resource DB 15c1-15cn in this embodiment shall be described in detail. FIG. 3 is an illustration showing a resource DB 15c1-15cn data description example. As shown in the drawing, resource DB 15c1-15cn describes, by way of working environment data, data indicating printer name, driver version, ink set and settable range. Settable range is a format describing, in order, data indicating “target item n, superordinate item number m, superordinate item n1 and value thereof . . . superordinate item m1 and value thereof, settable range.”

By so doing, it is possible to specify a settable range for a target item when an item value in a superordinate interdependency relationship is a specific value; for example, in the case that the target item is print quality, the superordinate item is type of print medium, and superordinate items number one, where the item value for print quality is “2, 3” when the item value for type of print medium is “1”, the description will be “print quality, 1, type of print medium=1, 2, 3”. Here as well, target items with no interdependency relationship are assigned an item number of “0”, and the item number of the superordinate item is described directly as the settable range, without describing any superordinate item and value thereof. By describing working environment data in the resource DB, it is possible to decide which resource DB should be used in which kind of working environment.

Adjustments of various kinds, such as already describing for X−1 of total number of items X, can be made to the number of target items described in resource DB 15c1-15cn. All items present as printing condition items of PRTDRV 21 may be described; or in order to avoid taking an extremely large amount of time in order to create resource DB 15c1-15cn, only target items having a number of superordinate items not exceeding a predetermined number (e.g. 4 or fewer) could be described. Alternatively, an arrangement whereby printing condition items that have low frequency of utilization on the UI are identified in advance, and these low use frequency items and/or printing condition items that are not shown on the UI (printing conditions that must be set in order execute printing, but that cannot be set by the user, being determined instead by the APL or the like) are not described in resource DB 15c1-15cn could be used.

In the manner described hereinabove, in printer DB 15b1-15bn and resource DB 15c1-15cn, item values for printing condition items are specified in terms of numeric values, with the meanings of numeric values being determined in advance. For example, type of print medium=1 is determined in advance as meaning “plain paper.” Accordingly, while the act of specifying printing conditions for printing condition items is referred to herein as “determining item values”, it is of course sufficient in the present invention to be able to specify printing conditions, it not being mandatory to identify printing conditions by means of numeric values, rather being possible to employ various other arrangements such as specification with text strings.

Further, data indicating printer name, target item, and other kinds of information mentioned hereinabove can be described in either printer DB 15b1-15bn or resource DB 15c1-15cn, with the form of data description not being limited to the format described above. Of course, in the sense of describing data, it is sufficient to indicate information of various kinds, it being possible in computer 10 to employ a text format, to employ a binary format, or to employ any of various other arrangements.

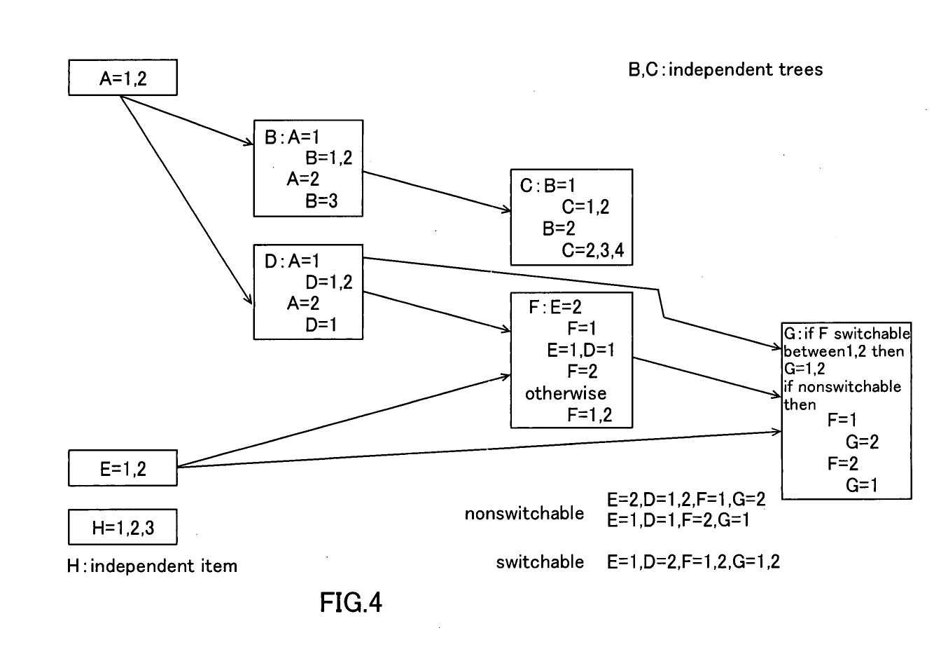

FIG. 4 is an illustration showing interdependency relationships together with settable ranges determined in the manner described above. In the drawing, A -H indicate printing condition items, with interdependency relationships shown by arrows. A printing condition item situated at the tip of an arrow is a subordinate item, and a printing condition item at the opposite end is a superordinate item. For example, printing condition item A represents a superordinate item for printing condition items B and D. Where items in an interdependency relationship have a one-to-one relationship of a superordinate item with a subordinate item, that is an interdependency relationship like that of B, C shown in FIG. 4, this is termed an independent tree; and where for a given item there are several subordinate items or superordinate items, i.e. an item like printing condition item F (having D and E as superordinate items) shown in FIG. 4 is termed a non-independent tree.

In the aforementioned printer DB 15c1-15cn indicating interdependency relationships for printing condition items, either independent trees or non-independent trees can be described, allowing complicated interdependency relationships to be described by an extremely simple format. That is, in the case of an independent tree, it would be acceptable for example to show printing condition item B as a superordinate item of printing condition item C; or in the case of a non-independent tree, it would be acceptable for example to show printing condition items D, E as two superordinate items of printing condition item F.

Additionally, in the aforementioned resource DB 15c1-15cn indicating settable ranges, since the settable range of a target item is indicated while indicating a superordinate item and a specific item value of the superordinate item, complex interdependency relationships and settable ranges like those shown in FIG. 4 can be described easily. In the drawing, for each printing condition item, item values of the superordinate item and item values of the target item in the item value are shown. For example, in printing condition item B, it is indicated that when the item value of superordinate item A is “1” the settable range for item B is “1, 2”, and when the item value of superordinate item A is “2” the settable range for item B is “3.”

In printing condition item F shown in FIG. 4, as shown in the drawing when superordinate item E is “2” item F is “1”, and when superordinate item E is “1” and superordinate item D is “1” item F is “2”, in other cases item F being “1, 2.” In this way, there is are complex interdependency relationships whereby when a superordinate item is a specific item value, the item value of item F is dependent on the superordinate item. However, even such interdependency relationships can be described in simple format in resource DB 15c1-15cn. That is, values for superordinate items and values for F in all instances, including the case where the aforementioned E=2 and the case where E=1 and D=1, are described in resource DB 15c1-15cn.

The case is similar for even more complex interdependency relationships, such as printing condition item G. With printing condition item G, conditions are that if superordinate value F is switchable between “1, 2” G is “1, 2”, and if not switchable, then when item F is “1” item G is “2” and when item F is “2” item G is “1”. That is, item G is dependent on the condition of whether item F is switchable, and also on the item value of F. Regarding the condition of whether item F is switchable or not, while this cannot be specified solely by an interdependency relationship between item F and item G, if items D, E—which are superordinate items for item F—are used as well, it becomes possible to specify a settable range for item G.

Accordingly, in this case items D, E, F represent superordinate items for item G; having specified item values for items D, E, F, by then describing a settable range for item G, it is possible to specify complex conditions, including whether or not item F is switchable as described above. Specifically, as shown at lower right in FIG. 4, nonswitchable refers to a case in which there is no discretion as to the settable range for item F, the item value being “1” only or “2” only, with item F being “1” only in E=2 as mentioned previously. Accordingly, in this case, the description in resource DB 15c1-15cn will describe items E, D, F as superordinate items for item G, and give an item value of “2” for item E, item values of “1, 2” for item D, an item value of “1” for item F, and a settable range of “2” for item G.

As regards the case where item F is “2” only, the description in resource DB 15c1-15cn will describe items E, D, F as superordinate items for item G, give item values of “1”, “1”, “2” for these respectively, and give a settable range of “1” for item G. Where switchable, it is acceptable to cite data wherein item values of the aforementioned superordinate items D, E, F are different from the values in the above example, and the settable range for item G is “1, 2.” In the above manner, in this embodiment, by employing in the resource DB 15c1-15cn a format that describes superordinate items and values thereof, it is possible to create a resource DB 15c1-15cn in which even complex interdependency relationships can be described simply.

(4) Print Control Process and UI Display Example:

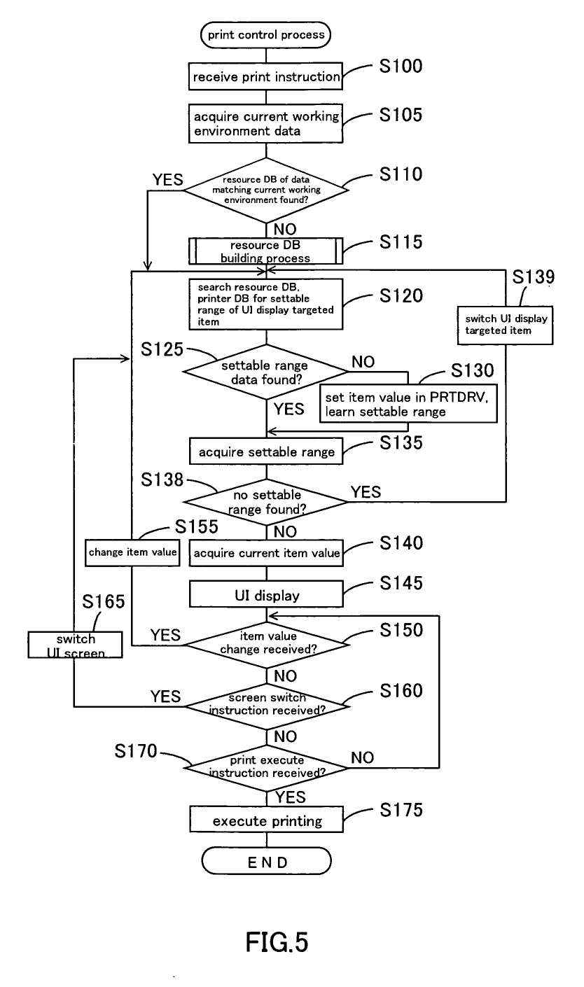

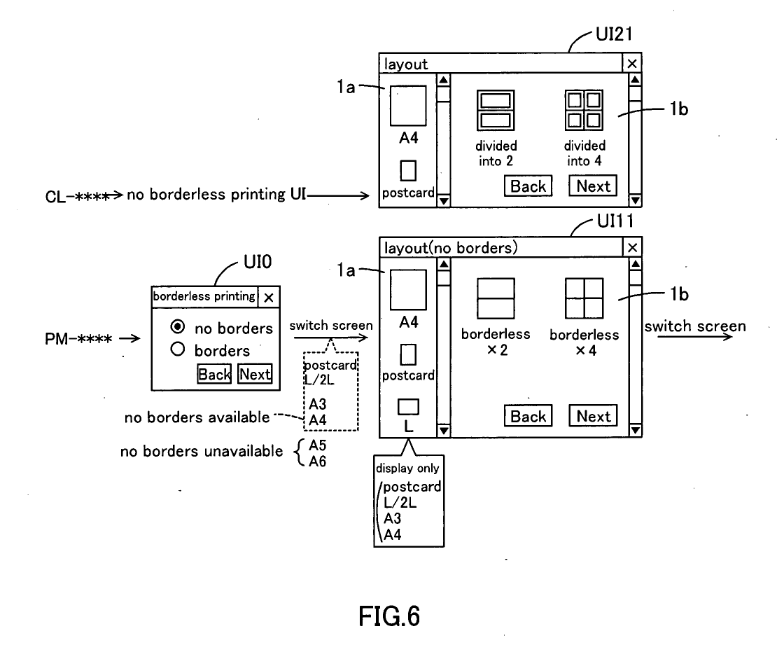

Next, a print control process and UI display example will be described. The print control process is carried out in accordance with the flow depicted in FIG. 5; FIG. 6 is an example of the UI displayed at this time. A user can issue a print instruction for an image targeted for retouching during execution of APL 25, and when image processor 25a receives the print instruction (Step S100), the UI display controller 25b controls UI display in collaboration with the UI control module 30. At this time, the resource DB creator 34 acquires data indicating the working environment in the computer 10 at this point in time, i.e. data indicating the name of the printer used, and data indicating the ink set and version of PRTDRV 21 that controls the printer (Step S105).

In this embodiment, it is verified that the printer model set as the default printer model in the OS 20 is actually connected, with resource DB creator 34 acquiring the model name of the printer by receiving data from PRTDRV 21a-21 via software I/F 27. In the event that the printer model set as the default printer model cannot be acquired, the UI display controller 25b concludes that there is an error and prompts re-specification of printer model. In the event that data indicating the default printer model can be acquired, data indicating this model name is designated as the printer name in the current working environment. That is, the OS 20 default or user-provided printer specification is handled, and in response to this data indicating working environment is acquired. Besides an arrangement whereby data indicating current working environment is implemented after handling a print instruction as in this embodiment, it would be possible to acquire it at periodic intervals and hold it, or other such arrangement.

Once data indicating current working environment is acquired in Step S105, the resource DB creator 34 in Step S110 refers to HDD it and determines whether there is stored in HDD 15 a resource DB describing working environment data matching said data. In Step S110 if it is not determined that there is stored in HDD 15 a resource DB describing working environment data matching the current working environment, in Step S115 the resource DB creator 34 executes a process to refer to the printer DB matching the current working environment and build a resource DB. If in Step S110 a resource DB is determined to already be stored, Step S115 is skipped.

By means of the above process, during printing for the first time after installing or version upgrading the PRTDRV 21 or modifying the ink set, a resource DB is built; and during a second or subsequent print operation, the process will proceeding appropriating the previous resource DB, without carrying out a building process. Since a certain amount of time is needed when building resource DB 15c1-15cn, an arrangement that shows the user that the process is proceeding by means of a progress bar or the like shown on the display would be preferred.

In the process starting at Step S120, the UI display controller 25b acquires settable ranges for printing condition items targeted for UI display, so that these can be displayed on a predetermined UI. In this process, a printer DB or resource describing working environment data that matches the current working environment is selected and targeted for the process. First, in Step S120 the item value settable range acquirer 33 searches the resource DB and printer DB in that order, and in Step S125 determines whether a printing condition item targeted for UI display is described as the aforementioned target item in the printer DB or resource DB describing working environment data that matches the current working environment.

In Step S125 if it not determined that the printing condition item targeted for UI display is described as the aforementioned target item, in Step S130 the resource DB creator 34 actually sets an item value for PRTDRV 21 and acquires a settable range. That is, making reference to the printer DB, it determines whether there is a superordinate item for the printing condition item targeted for UI display, and in the event that a superordinate item exists, sets via software I/F 27 the item value for this superordinate item in the PRTDRV corresponding to the printer used in the current working environment, and then acquires the settable range that the printing condition item targeted for UI display can assume with the item value of the superordinate item set in this manner.

For these superordinate item item values, all possible item values assumable by the superordinate item are set sequentially, acquiring settable ranges that the printing condition item targeted for UI display can assume given each item value of the superordinate item. In the event that a superordinate item does not exist for a printing condition item targeted for UI display, the settable range for the printing condition item is acquired via software I/F 27, without setting item values for items other than printing condition items targeted for UI display. The settable range so acquired is described in the resource DB. Accordingly, even where a printing condition item targeted for UI display has not been described in a resource DB and a printer DB, a determination that it is not described will not be made at the time of next printing.

Since this Step S130 involves a process of acquiring a settable range upon having actually set an item value for the PRTDRV 21, it may be somewhat time consuming. However, conditions under which a printing condition item targeted for UI display is not described in a resource DB can occur are limited to specific cases, such as when avoiding an excessively long period of time to create the resource DB, and thus substantially all items needed to carry out UI display will be described in the resource DB. Accordingly, in actual practice Step S130 is rarely performed.

In Step S135, the item value settable range acquirer 33 acquires a settable range for a printing condition item detected to be described in a printer DB or resource DB or printer DB 15b in Step S120, or a printing condition item described in a resource DB in Step S130. In Step S138, it is determined whether the settable range for the printing condition item in question is “none”, i.e. whether it is possible to select any item value for it.

In Step S138 if it is determined that the settable range is “none”, in Step S139 the printing condition item targeted for UI display is switched, and the process starting at Step S120 is repeated. By means of this process, UI display is not carried out for printing condition items for which settable item values do not exist. If in Step S138 it is not determined that the settable range is “none”, in Step S140, the item value acquirer 32 refers to provisional settings 14a in RAM 14, or acquires the current item value via software I/F 27.

That is, in the loop process starting at Step S120, in the initial iteration an item value of the printing condition item at the previous time that printing was executed is acquired, and transferred as the current item value to the UI display controller 25b. At this time, the current item value is recorded as a provisional setting 14a in RAM 14. In the second and subsequent iterations of the loop process starting at Step S120, reference is made to provisional settings 14a in RAM 14 to acquire the item value for transfer to the UI display controller 25b.

In Step S145, the settable range acquired in Step S135 is made into selectable decision branches, and the provisional setting acquired in Step S140 is displayed in provisionally set format on the UI. Then, in Step S150, a determination is made as to whether the UI display controller 25b has handled a change in the item value, and if it is determined that a change in the item value had been handled, in Step S155 the item value provisional setter 31 acquires the changed item value as the provisional setting, updates the provisional settings 14a in RAM 14, and repeats the process starting at Step S120.

In this repeat process, even if interdependency relationships of a printing condition item targeted for UI display should change due to a change in the item value of Step S155, an appropriate settable range will be acquired by means of the process of Step S135, and in the UI display of Step S140 it will be possible to update the UL without showing unselectable printing condition items as if these were selectable. Also, in the repeat process, when acquiring the current item value in Step S140, the item value is not set for PRTDRV 21 via the software I/F 27. Accordingly, in the event that a item value on the UI should change even once between the time that the UI is displayed until printing is executed, the UI display can be switched quickly.

In the UI pertaining to this embodiment, only some of all of the printing condition items the user will be prompted to select are displayed on any single screen, with a smaller number of printing condition items being input from any single screen while serially switching screens until the final print execute instruction is received. Thus, in Step S160, a determination is made as to whether the UI display controller 25b has received a screen switch instruction, and if it is determined that a screen switch instruction has been received, the UI screen is switched in Step S165. After switching, the process starting at Step S120 is repeated in order to produce a proper display for printing condition items targeted for UI display.

In Step S160, if it is not determined that a screen switch instruction has been received, in Step S170 the UI display controller 25b determines whether a print execute instruction has been received. Then, if determined that a print execute instruction has been received, in Step S175 the print executer 25c outputs image data targeted for printing to the PRTDRV 21, as well as outputting to the item value provisional setter 31 an instruction to set printing conditions. The item value provisional setter 31 then accesses the software I/F 27 and sets the printing condition items recorded in the provisional settings 14a for the PRTDRV 21. As a result, the PRTDRV 21 carries out image processing according to the printing conditions as well as creating print data for executing printing according to the printing conditions, and outputs this to printer 40 which executes printing.

FIG. 6 shows switching of UI screens in this embodiment. With the UI according to this embodiment, only some of all of the printing condition items the user will be prompted to select are displayed on any single screen, with a smaller number of printing condition items being input from any single screen while serially switching screens until the final print execute instruction is received. In the example shown in FIG. 6, there is shown an example of a UI screen for a printer capable of executing borderless printing (in FIG. 6, model PM-****) and a printer not capable of borderless printing (in FIG. 6, model CL-****).

In model PM-****, since borderless printing is possible, the settable range for the printing condition item can be either “no border” or “border” depending on interdependency relationships with other printing condition items. On the other hand, in model CL-****, since borderless printing is not possible the settable range for the printing condition item will be “none”, with there being no decision branches for the settable range. In this embodiment, where the settable range of a printing condition item varies depending on the working environment (in FIG. 6, the printer model) in this way, the arrangement is such as to avoid displaying unnecessary screens or settable ranges so as to display UI screens which correctly correspond to the current working environment.

In FIG. 6, UI for selecting print medium layout are designated UI11 and UI21. UI11 is the UI screen for model PM-****, and UI12 is the UI screen for model CL-****. In UI11 and UI12, a frame 1a for selecting print medium size as a printing condition item is shown at left, and a frame 1b for selecting layout as a printing condition item is shown at right. UI0 in FIG. 6 is a UI for selecting whether to carry out borderless printing (printing with no margins at the four edges of the medium).

In each UI, printing condition items can be selected by means of clicking a radio button or icon; the “Back” button at lower right of the screen moves back to the preceding UI screen, and the “Next” button advances to the next UI screen, and in the last UI a print execute instruction can be made by means of a print execute instruction button. In this example, layout defines image layout on the print medium, with print medium size being a superordinate condition for layout. In the model PM-**** printer, print medium size is limited to those for which borderless printing is possible, and in this sense borderless printing ability is a superordinate condition for print medium.

In the example of FIG. 6, the model PM-**** printer is able to print postcard, L, 2L, and A3-A6 print medium sizes; of these, borderless printing is possible with the postcard, L, 2L, A3 and A4 print medium sizes. Accordingly, there is created an APL 21 displaying a borderless printing decision branch as UI display target item by the aforementioned UI display controller 25b, and in the case of the model PM-**** printer, Step S140 is carried out after making the determination in Step S138. As a result, for borderless printing, there is displayed a UI for selecting “no borders” or “borders.”

On the other hand, even where an APL 2l displaying a borderless printing decision branch as UI display target item has been created, where model CL-**** is the currently used printer, Steps S139 and S120 are carried out after making the determination in Step S138, so a UL for selecting borderless printing is not displayed. UI0 is skipped, and UI21 for carrying out layout display is displayed.

Also, where model PM-**** is the currently used printer, when “no borders” and “borders” are displayed as a settable range in UI0, and “no borders” is selected while proceeding to the next UI1, in frame 1a, postcard, L, 2L, A3 and A4 will be displayed as the settable range. In UI0, where “borders” is selected while proceeding to the next UI1, in frame 1a, postcard, L, 2L, and A3-A6 will be displayed as the settable range.

Also, where print medium size has been selected in frame 1a of UI1, frame layout will be updated automatically in frame 1b, and only those layouts which are printable with the print medium size currently selected will be presented by way of the settable range. Of course, in the model CL-****, where print medium size is dependent upon a printing condition item set in the UI screen preceding UI21, the print medium size decision branch can vary with the item value thereof.

In the above manner, in the UI pertaining to this embodiment, simply by means of the creator of APL 25 selecting desired printing condition items and establishing these as targets for display on the UI, there can be implemented a UI display capable of providing exclusively appropriate displays of settable ranges for item values, acquired by the UI control module 30, with reference to the current working environment, and able to display screens easily and quickly, with a high degree of freedom of selection of display targets.

Further, in the UI pertaining to this embodiment, since interdependency relationships exist among printing condition items, it is preferable to employ an arrangement whereby successive screen switching is carried out such that selection is made starting with superordinate printing condition items. Where a given item has a number of superordinate items, it is preferable for these superordinate items to be selected on the same UI screen. Further, an arrangement for a UI wherein a large number of printing condition items are displayed on a single screen would be acceptable; and in the event that the setting of a certain printing condition item produces a change in the settable range of another printing condition item, non-selectable item values are not displayed as decision branches, while selectable item values are displayed as decision branches. Of course, various arrangements for the UI arrangement are possible; an arrangement whereby non-selectable item values are shown grayed out could be employed.

(5) Resource DB Building Process:

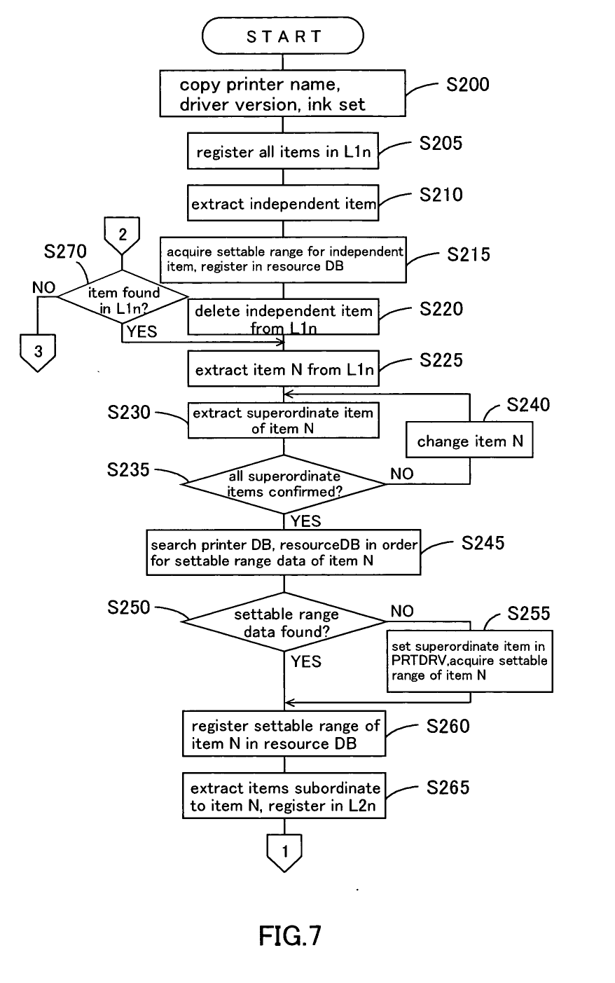

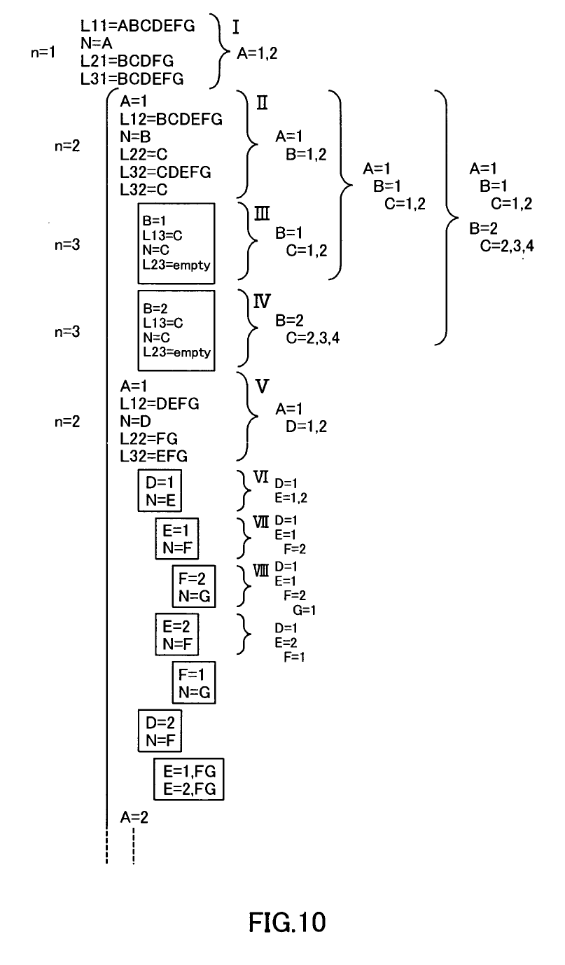

Next, the process of building a resource DB in the aforementioned Step S115 will be described. FIGS. 7 to 9 are flowcharts showing this building process; FIG. 10 is an illustration describing an example of processing when building a resource DB. The following description relates to the flowcharts of FIGS. 7 to 9 for the example shown in FIG. 10. In the resource DB building process, RAM 14 serves as the work area, and data for listing printing condition items is buffered therein as the process proceeds, with the resource DB being created while switching lists appropriately depending on the purpose of buffering and the loop.

In Step S110 in FIG. 5, if it is not determined that that there is stored in HDD 15 a resource DB describing working environment data that matches the current working environment, in Step S115 the resource DB creator 34 executes the process of Step S115 and initiates a routine beginning with Step S200 in FIG. 7. First, data indicating the current working environment acquired in Step S105 is registered in the resource DB. In Step S205, all items are extracted from the printer DB by which is described the data indicating the current working environment and registered in a list L1n. This list L1n is a list registering unconfirmed items whose settable ranges are not yet confirmed. In the process of FIGS. 7-9, number n is a natural number with an initial value of “1”; by means of this number, different lists are buffered and are used selectively depending on the stage of the loop.

In Step 210, an item having no superordinate item or subordinate item (i.e., an independent item) in list L1n is extracted, and in Step S215 the PRTDRV 21 is requested via software I/F 27 for the settable range of the independent item, the settable range so acquired being registered in resource DB. In the example shown in FIG. 4, since printing condition item H has no superordinate item or subordinate item, its settable range (in FIG. 4, “1, 2, 3”) is acquired and registered in resource DB.

Since an independent item registered in resource DB in this way is no longer an unconfirmed item, in Step S220 it is deleted from list L1n. In Step S225 and subsequent, for items having interdependency relationships, item values are determined starting from superordinate items, and the process proceeds such that when a superordinate item is that item value, the settable range for the subordinate item is acquired. Thus, in Step S225, item N is extracted from list L1n, and in Step S230 reference is made to the printer DB describing data indicating the current working environment to extract superordinate items for the item N.

In Step 235, a determination is made as to whether all extracted superordinate items have been confirmed (if any superordinate item for the item N is present in list L1n, it is deemed unconfirmed), and if not determined that all have been confirmed, in Step S240 item N is changed, and the process starting with Step S230 is repeated. That is, by means of this loop, there proceeds a process in which the highest level item, i.e. one having no any superordinate item, is designated as item N. In FIG. 10, an example of lists buffered in process starting with Step S220 for the interdependency relationships given in FIG. 4 is shown in a time series going from top to bottom. At this stage, number n is at its initial value so list L1n is list L11; as shown in (a) in the drawing, list L11=ABCDEFG. In the example shown in (a), item A has been extracted as item N.

In Step 235, if it is determined that all superordinate items have been confirmed, then in Step S245 settable range data for item N is searched for in the printer DB describing data indicating the current working environment and in the resource DB being created, in that order; and in Step S250 a determination is made as to whether settable range data for item N is present in the printer DB or resource DB. If it is determined in Step S250 that settable range data for item N is present, Step S255 is skipped, and in Step S260 the settable range data is registered in the resource DB being created.

If it is not determined in Step S250 that settable range data for item N is present, in Step S255 the item value for the superordinate item is set in PRTDRV 21 via the software I/F 27, and the settable range for item N is acquired. The, in Step S260, the settable range data is registered in the resource DB being created. The reason for giving priority to the printer DB in Step S245 is that in some instances it may not be possible to properly acquire a settable range form PRTDRV 21 due to the occurrence of an error or the like as noted previously; in such instances, since the proper settable range is described in the printer DB, the printer DB is searched first.

The reason for searching the resource DB next is in order to prevent duplicate settings from being made for the PRTDRV 21; where settable range data is already present in the resource DB, a settable range is acquired from the resource DB without making settings for the PRTDRV 21. That is, in the process of this embodiment, a process of determining item values for superordinate items and acquiring settable ranges for subordinate items thereof is carried out sequentially going from more superordinate to more subordinate values, so that even if the item value of the level two higher than item N (designated level M) differs, provided that the item value of the level one higher than item N (level M+1) is a shared value, the settable range for item N will be shared.

Accordingly, in the process of Step S245, in some instances there will be detected settable range data previously described for the settable range of item N, and in such instances Step S255 is skipped. In this way, by first searching the printer DB and the resource DB, where settable range data is discovered by the search there is not need to make settings in the PRTDRV 21, it being possible to acquire a settable range simply by referring to HDD 15. Accordingly, a settable range can be acquired more quickly than when a superordinate item is set for the PRTDRV 21 via the software I/F 27, and the settable range of a subordinate item thereof acquired.

In the process of item value N=A shown in FIG. 10(a), since it is the outset of the process and no settable range for item A is stored in the resource DB has been created, after going through the process of Steps S245 and S250, in Step S255 settable range data (A=1, 2) is acquired via PRTDRV 21. In this example, since item A has no superordinate item, settable range data for item A can be acquired without setting a superordinate item in Step S255.

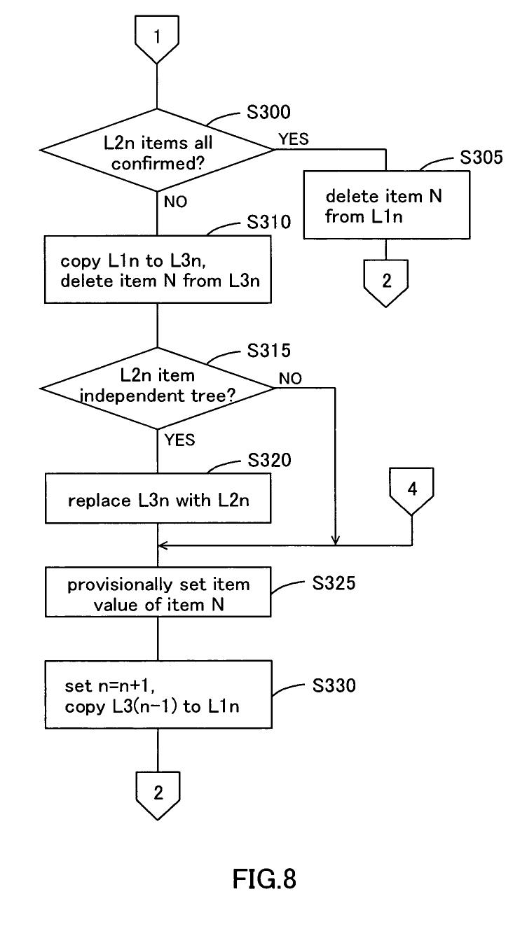

In Step S265, referring to printer DB, items subordinate to item N are acquired and registered in list L2n. That is, list L2n is a list cataloging subordinate items that are dependent on item N. Accordingly, in the example shown in FIG. 10(a), all subordinate items—with the exception of item E which is not dependent on item A—are registered in the number n=1 list L2n, whereby list L21=BCDEFG. After the process in Step S265, in Step S300 of FIG. 8 a determination is made as to whether settable ranges have been confirmed for all items of list L2n.

In Step S300, if it is determined that settable ranges have been confirmed for all items of list L2n, in Step S301 item N is deleted from list L1n, and the process starting with Step S270 of FIG. 7 is carried out. In Step S300, if it is not determined that settable ranges have been confirmed for all items of list L2n, in Step S310 list L1n is copied to list L3n, and item N is deleted from list L3n. That is, since the items of list L2n are subordinate items of item N, if it is determined in Step S300 that these subordinate items have been confirmed, since this means that item N and its subordinate items have been confirmed, item N is deleted from the unconfirmed item list L1n, and the process proceeds for the remaining unconfirmed items.

In Step S300, if it is not determined that subordinate items of item N have been confirmed, in order to confirm the subordinate items, the unconfirmed items, excluding item N, are put into list L3n, and the process proceeds. In this sense, list L3n is a list registering some unconfirmed items. List L3n is also a list for temporarily registering some unconfirmed items carrying out processing in each loop. In the example shown in FIG. 10(a), since items BCDFG of list L21 are not confirmed, after the decision of Step S300, in Step S310 L31=BCDEFG.

In Step S315, a determination is made as to whether items of list L2n are an aforementioned independent tree. In Step S315, if it is determined that items of list L2n are an independent tree, in Step S320 list L3n is replaced with list L2n. That is, subordinate items of an independent tree are registered in list L3n as targets for processing in the loop. In Step S315, if it is not determined that items of list L2n are an independent tree, Step S320 is skipped. In the example shown in FIG. 10(a), Step S320 is skipped.

In Step S325, the item value of item N is provisionally set. Specifically, in order to determine settable ranges for subordinate items with item N set to a specific value, the item value of item N is provisionally set to a specific value. When Step S325 is executed again by being repeated for a given item N, the provisionally set item value will be a value different from that in the preceding process. In Step S330, number n is incremented, and list L3(n−1) is copied to list L1n. That is, unconfirmed items in the loop in the preceding number (n−1) are copied to the unconfirmed items.

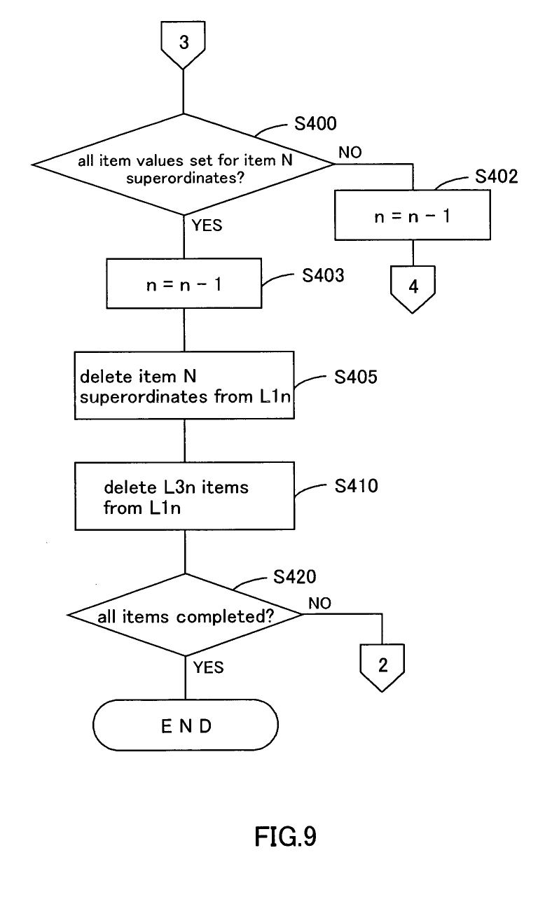

In Step S270 a determination is made as to whether items are present in list L1n; if items are present, unconfirmed items will be present, so the process beginning with Step S225 is repeated. If in Step S270 it is not determined that items are present in list L1n, the process beginning with Step S400 shown in FIG. 9 is executed. In the example shown in FIG. 10(b), there is shown an example wherein item N=A and A=1 is the provisional setting in Step S325; in Step S330 and subsequent, number n goes to “2” so list L12=BCDEFG.

In the illustrated example, list L12=BCDEFG and in Step S270 items are present in list L12, so in Step S225 a new item N is set. In FIG. 10(b) the new item N is item B; since settable ranges of the superordinate value A of this item B have all been confirmed, after making the determination of Step S235, the process of Steps S245-S255 is carried out. At this time, since the settable range of item B is not registered in the printer DB describing data indicating the current working environment and in the resource DB being created, in Step S255 the aforementioned provisionally set item A=1 is set in PRTDRV 21, and the item B settable range B=1, 2 is acquired. As a result, in Step S260, where A=1 is the settable range data of item B, B=1, 2 will be registered in the resource DB.

Continuing the process, in Step S265 the designation list L22=C is made, in Step S310 the designation list L32=CDEFG is made, and in Step S320 the designation list L32=C is made. In Step S325, in order to carry out the process for subordinate item C of item B, the provisional setting of item B=1 is made, in Step S330 the designation list L13=C is made. Upon returning to Step S270, since item C is present in list L13, the process starting with Step S225 is repeated, and the process is performed for item N=C (FIG. 10(c)). In the process of Steps S245-S260, where B=1 is the settable range data of item C, C=1, 2 will be registered in the resource DB.

In Step S265, since there are no items subordinate to item N=C, L23 is designated as empty; in Step S300 it is determined that, since items of L23 are empty, all items have been confirmed, whereupon in Step S305 list L13 is designated as empty, and the determination of Step S270 is made. At this time, since list L13 is empty, the process of Step S400 of FIG. 9 is carried out. In Step S400, a determination is made as to whether all item values have been set for superordinate items of item N; in Step S402, number n is decremented, and the process starting with Step S325 is repeated. If it is determined in Step S400 that all item values have been set for superordinate items of item N, in Step S403, number n is decremented, and the process starting with Step S405 is carried out.

In the example shown in FIG. 10, since item value 2 has not been set for superordinate item B of item N=C, in the process of Step S325, item value 2 is set for superordinate item B (FIG. 10(d)). Then, in Step S330, list L32 is copied to list L12, and the designation list L13=C is made. Subsequently, in Steps S270 and S225-S260, a process analogous to that described above is carried out, whereby when settable range data for item C is B=2, C=2, 3, 4 is registered in the resource DB. As a result, settable ranges are confirmed for items B and C.

In Steps S265-S305 and S270 of this case as well, there is made a determination analogous to that in the case of B=1 described previously; however, in Step S400, since the determination is that settings are complete for all item values for superordinate [item] B of item C, the process beginning with Step S403 is now carried out. In Step S405, superordinate items item N are deleted from list L1n, and in Step S410 the items of list L3n are deleted from list L1n. In the example shown in FIG. 10, superordinate item B of item C is deleted from list L12 in Step S405. As a result, list L12=CDEFG. Additionally, in Step S410, the items of list L32 are deleted from list L12. As a result, list L12=DEFG (FIG. 10(e)).

In Step S420, a determination is made as to whether registration of settable range data has been completed for all items described in the printer DB in which is described data indicating the current working environment, repeating the process starting with Step S270 until this is determined to have been completed. In the example shown in FIG. 10(e), at the stage in which list L12=DEFG, since these items are unconfirmed, the process starting with Step S270 is repeated with number n=2. In FIG. 10(e), there is shown an example of a case where item N=D in Step S225 when this number n=2 and list L12=DEFG. In this case, after a process analogous to the process for determining item B=1, 2 when item A=1, as described previously, in Step S260, where the settable range data for item D is A=1, D=1, 2 is recorded in the resource DB.

Then, in Step S265, it is designated that list L22=FG, and through the determination of Step S300 it is designated that list L31=EFG. Since FG of list 22 are not an independent tree, after the determination of Step S315 Step S320 is skipped, and in Step S325 the provisional setting item D=1 is made, and the process after S330 continues. Subsequently, in accordance with the flowcharts shown in FIGS. 7-9, first, with item D=1 and E=1 as shown in FIG. 10(g), settable range data for item F is registered; then with item D=1, E=1, and F=2 as shown in FIG. 10(h), settable range data for item G is registered.

In this case, once settable range data for item G has been registered, a process to register settable range data for item F and item G with the settings item D=1 and E=2 is then carried out. That is, by carrying out a process in accordance with the flowcharts shown in FIGS. 7-9, item values are set sequentially beginning with superordinate items, setting subordinate items step by step while registering settable range data at those item values. By so doing, for all instances in which interdependency relationships exist, there can be carried out a process for setting superordinate item values and registering settable range data for items subordinate thereto. Accordingly, it is easy to specify settable range data among items having complex interdependency relationships such as printing condition items F and G as shown in the aforementioned FIG. 4, and to create a resource DB corresponding to the current working environment.

(6) Other Embodiments

In the present invention, it is sufficient to refer to interdependency relationships and settable ranges of working conditions of a peripheral, and to display a UI within settable ranges depending on the current working environment while enabling the user to set working conditions, various arrangements for doing so being possible besides the embodiment described hereinabove. For example, in the embodiment hereinabove, there is employed an arrangement whereby a resource DB is created by referring to a printer DB recorded on HDD 15, at least prior to setting printing conditions from the UI in computer 10, but it would of course be possible to instead create the resource DB on another computer besides computer 10, and then record it onto HDD 15.

That is, it would be possible to employ an arrangement whereby the printer manufacturer providing the printer 40 creates in advance a resource DB corresponding to the working environment, e.g. the printer, driver version, etc.; and provides to the user of computer 10 a medium having the PRTDRV 21 program and resource DB data recorded thereon, with the resource DB being recorded on the HDD 15 during installation of the PRTDRV 21. By means of such an arrangement, there is no need to provide a printer DB for creating a resource DB on computer 10, whereby it is possible to hold down the data capacity required of the HDD 15. Additionally, since there is no need to create a resource DB when the user is operating the computer, no time is needed for creation thereof, and the user need not be made to wait from the initial UI display.

On the other hand, in the arrangement described above wherein a resource DB is created by referring to a printer DB recorded on HDD 15, since it is possible to easily rebuild the resource DB in the event of a change in the working environment, e.g. a change in driver version or ink set as described above, it is a simple matter to accommodate changes in conditions. Also, even in the event that settable ranges cannot be acquired properly from the PRTDRV 21 due to an error or the like, since it is sufficient for appropriate settable range data to be recorded in the printer DB, in the event that such an error should occur it will be easy to correct.

Registration of settable range data in resource DB 15c1-15cn is not limited to the time of building in the aforementioned Step S115 or during learning of settable range in Step S130; predetermined settable range data could instead be registered after executing printing, for example. That is, there is no need for correct values when used during preview of, for example, print area settings on the UI; if the data is of a kind for which correct values are needed at the time of printing, settable ranges therefor may be acquired when setting the print area in PRTDRV 21 at the time of printing, and recorded in resource DB 15c1-15cn. With such an arrangement, it is possible to prevent settings for the PRTDRV 21 from being made during UI display, so that the UI display process may be carried out faster; once the settable range data has been recorded in resource DB 15c1-15cn, correct values can then be used rapidly.

The resource DB creation flowchart hereinabove is merely exemplary, it being sufficient simply to carry out a procedure for acquiring settable ranges of subordinate items once the item value of a superordinate item has been determined, this procedure being carried out sequentially going from superordinate to subordinate items; various other flows would be possible instead. It is not essential to use the lists described hereinabove; the process could proceed while carrying out buffering by means of some other method. Also, while there is employed an arrangement whereby when acquiring current item values in Step S140 of FIG. 5, in the initial loop process, the PRTDRV 21 is requested for item values via software I/F 27, there would of course be possible instead an arrangement whereby after UI setting has been completed, provisional settings are held in memory by being transferred to nonvolatile memory as needed, these provisional settings being referred to in the initial loop process so that a request to the PRTDRV 21 need not be made.

Further, where character strings corresponding to item values are recorded together with item values as settable ranges for printing condition items in the resource DB as described above, it becomes possible to clearly indicate item values by means of text during display of settable ranges on the UI, so as to provide a UI that is easier to understand. Of course, various display modes are possible for the UI; in addition to an arrangement as described above, wherein a UI screen is displayed or not depending on the working environment, there could also be employed an arrangement wherein display contents change. For example, there could be employed an arrangement whereby in the event that an ink set is modified, the nature of ink set is displayed, for example, by switching displays indicating ink color, pigment/dye, etc. By means of such an arrangement, proper UI display can be carried out automatically in the event that the user modifies the ink set.

Further, whereas in the embodiment hereinabove the invention is implemented in a printer as the peripheral connected to a computer, the invention could of course also be implemented in any peripheral having working conditions settable by means of a UI. For example, the invention could be implemented in a display, projector, scanner, digital camera, hard disk drive, or the like. In the present invention, since appropriate settable ranges depending on working environment are identified by settable range data for working conditions with complex interdependencies, it is preferable to implement the invention in cases where numerous working conditions exist, or where peripherals have numerous interdependency relationships. In this sense, a scanner or the like would be a favorable implementation example, or a multifunctional device combining a scanner, printer, copier and fax in a single unit would be a favorable implementation example.

Further, data indicating working environment is not limited to data indicating printer model, driver version and/or ink set as described hereinabove, it being possible to employ various other working environment [parameters]. For example, working environment may be made to differ where locale information differs. That is, as shown by locale information 24 in FIG. 1, locale information is recorded as data that can be referenced in the OS 20, whereby it is possible to specify the country and language used by computer 10.

Thus, by constituting working environment data so as to include this locale information, it becomes possible to create a different resource DB in the event that the country and/or language in the OS 20 differs. As a result, in the UI is it possible to carry out display depending on country and language settings. In particular, this is favorable in cases where text string data is included as settable range data, in which case it is possible to adapt to the UI display language, so that settable range can be displayed appropriately regardless of which language is used.

Further, in the embodiment hereinabove, whereas in the event that data indicating current working environment and working environment data described in a resource DB are different, a resource DB is built, it is not always necessary to rebuild the resource DB in the event that the two differ, it being possible to provide a certain amount of latitude when determining whether the two match. For example, there could be employed an arrangement whereby data indicating an appropriate range for driver version is described for the aforementioned printer DB, and when data indicating driver version acquired by way of the current working environment is not within the appropriate range of the driver version described in the printer DB, a resource DB is built. That is, where a settable range is unchanged by an update in the driver version, the updated version would be included in the appropriate range so that the resource DB will not be built after the update. By means of this arrangement, more flexibility can be provided in the determination of whether to build the resource DB.

1. Working condition acquisition method for extracting a settable range of working conditions of a peripheral connected to a computer, said working condition acquisition method comprising:
a working condition acquisition step wherein interdependency relationship data stored in a predetermined storage medium said interdependency relationship data indicating interdependency relationships among said working conditions, is referred to, and in the event that a specific working condition of said peripheral is a certain condition, the settable range of another working condition is acquired; and
a settable range data storage step wherein settable range data indicating the settable range of said acquired working condition is stored in a predetermined storage medium.

2. Working condition acquisition method according to claim 1 wherein said settable range data includes working environment data identifying the working environment of said peripheral,
and wherein said working condition acquisition step, in the event that settable range data including working environment data that matches the current working environment of the peripheral is not recorded in said predetermined storage medium, sets a specific working condition to a specific setting, and refers to said interdependency relationship data to acquire the settable range for another working condition dependent on said specific working condition.

3. Working condition acquisition method according to claim 2 wherein said peripheral working environment is identified by means of the peripheral model; the existence of an update of a component that enables said working condition acquisition step; components of said peripheral; locale information on said computer; or any combination thereof.

4. Working condition acquisition method according to claim 2 wherein said working condition acquisition step comprises a working environment handling step for handling specification of the working environment of said peripheral, wherein said current working environment of the peripheral is determined when handling said specification.

5. Working condition acquisition method according to claim 2 wherein said working condition acquisition step determines wherein said current working environment of the peripheral at predetermined timing when said computer is booted up.

6. Working condition acquisition method according to claim 1 wherein said working condition acquisition step is able to communicate with said peripheral to acquire data indicating the model of said peripheral and components of the peripheral.

7. Working condition acquisition device according to claim 1 wherein said predetermined storage medium, when storing said settable range data in said predetermined storage medium, holds stored settable range data without updating it.

8. Working condition acquisition device for extracting a settable range of working conditions of a peripheral connected to a computer, said working condition acquisition device comprising:
an interdependency relationship data storage medium for storing interdependence relationship data indicating interdependency relationships among said working conditions;
a working condition acquirer that refers to said interdependency relationship data, and in the event that a specific working condition of said peripheral is a certain condition, acquires the settable range of another working condition; and
a settable range data storage medium for storing settable range data indicating the settable range of said acquired working condition.

9. Working condition acquisition program product for extracting a settable range of working conditions of a peripheral connected to a computer, said working condition acquisition program product comprising:
a working condition acquisition function wherein interdependency relationship data stored in a predetermined storage medium, said interdependency relationship data indicating interdependency relationships among said working conditions, is referred to, and in the event that a specific working condition of said peripheral is a certain condition, the settable range of another working condition is acquired; and
a settable range data storage function wherein settable range data indicating the settable range of said acquired working condition is stored in a predetermined storage medium.

10. UI control device for extracting a settable range of working conditions of a peripheral connected to a computer, said UI control device comprising:
an interdependency relationship data storage medium for storing interdependency relationship data indicating interdependency relationships among said working conditions;
a settable range data storage medium able to store settable range data indicating settable ranges of said working conditions, said settable range data including working environment data specifying the working environment of said peripheral;
a working condition acquirer that, in the event that there is not recorded in said settable range data storage medium settable range data including working environment data that matches the current working environment of the peripheral, sets a specific working condition in said peripheral to a specific setting, refers to said interdependency relationship data to acquire a settable range for another working condition dependent on said specific working condition, and stores the settable range as settable range data in said settable range data storage medium;
a working condition input/output interface that refers to settable range data including environment data that matches the current working environment of the peripheral to acquire the settable range of said working condition, and displays on a predetermined output device a decision branch for selecting said working condition within said settable range as well as handling input of working condition settings; and
a working condition updater that refers to said settable range data and acquires the settable range of a working condition dependent on a working condition changed by input of said setting, and displays on a predetermined output device the settable range of said dependent working condition.

11. UI control method for extracting a settable range of working conditions of a peripheral connected to a computer, said UI control method comprising:
storing in a predetermined storage medium interdependency relationship data indicating interdependency relationships among said working conditions;
storing in a predetermined storage medium settable range data indicating settable ranges of said working conditions, said settable range data including working environment data specifying the working environment of said peripheral;
a working condition acquisition step wherein, in the event that there is not recorded in said settable range data storage medium settable range data including working environment data that matches the current working environment of the peripheral, a specific working condition in said peripheral is set to a specific setting, and reference is made said interdependency relationship data to acquire a settable range for another working condition dependent on said specific working condition, which is stored as settable range data in said settable range data storage medium;
a working condition input/output step wherein reference is made to settable range data including environment data that matches the current working environment of the peripheral to acquire the settable range of said working condition, and there is displayed on a predetermined output device a decision branch for selecting said working condition within said settable range as well as handling input of working condition settings; and
a working condition update step wherein reference is made to said settable range data to acquire the settable range of a working condition dependent on a working condition changed by input of said setting, and there is displayed on a predetermined output device the settable range of said dependent working condition.

12. UI control program product for extracting a settable range of working conditions of a peripheral connected to a computer, said UI control program product comprising:
storing in a predetermined storage medium interdependency relationship data indicating interdependency relationships among said working conditions;
storing in a predetermined storage medium settable range data indicating settable ranges of said working conditions, said settable range data including working environment data specifying the working environment of said peripheral;
a working condition acquisition function whereby, in the event that there is not recorded in said settable range data storage medium settable range data including working environment data that matches the current working environment of the peripheral, a specific working condition in said peripheral is set to a specific setting, and reference is made said interdependency relationship data to acquire a settable range for another working condition dependent on said specific working condition, which is stored as settable range data in said settable range data storage medium;
a working condition input/output function whereby reference is made to settable range data including environment data that matches the current working environment of the peripheral to acquire the settable range of said working condition, and there is displayed on a predetermined output device a decision branch for selecting said working condition within said settable range as well as handling input of working condition settings; and
a working condition update function whereby reference is made to said settable range data to acquire the settable range of a working condition dependent on a working condition changed by input of said setting, and there is displayed on a predetermined output device the settable range of said dependent working condition.

13. Printing control method for setting by means of a UI printing conditions of a printer connected to a computer as well as controlling the printer under printing conditions set from the UI, said printing control method comprising:
storing in a predetermined storage medium interdependency relationship data indicating interdependency relationships among said printing conditions;
storing in a predetermined storage medium settable range data indicating settable ranges of said printing conditions, said settable range data including working environment data specifying the working environment of said printer;
a printing condition acquisition step wherein, in the event that there is not recorded in said settable range data storage medium settable range data including working environment data that matches the current working environment of the printer, a specific printing condition in said printer is set to a specific setting, reference is made to said interdependency relationship data to acquire a settable range for another printing condition dependent on said specific printing condition, and this is stored as settable range data in said settable range data storage medium;
a printing condition input/output step wherein reference is made to settable range data including environment data that matches the current working environment of the printer to acquire the settable range of said printing condition, and there is displayed on a predetermined output device a decision branch for selecting said printing condition within said settable range as well as handling input of printing condition settings;
a printing condition update step wherein reference is made to said settable range data to acquire the settable range of a printing condition dependent on a printing condition changed by input of said setting, and there is displayed on a predetermined output device the settable range of said dependent printing condition;
a print executing instruction handling step wherein an instruction to execute printing at printing conditions in said handled settings is handled; and
a print control step wherein a printer is driven at printing conditions in said handled settings in response to an instruction to execute printing, to print an image.

14. Printing control device for setting by means of UI printing conditions of a printer connected to a computer as well as controlling the printer under printing conditions set from the UI, said printing control device comprising:
an interdependency relationship data storage medium for storing interdependency relationship data indicating interdependency relationships among said printing conditions;
a settable range data storage medium able to store settable range data indicating settable ranges of said printing conditions, said settable range data including working environment data specifying the working environment of said printer;
a printing condition acquirer that, in the event that there is not recorded in said settable range data storage medium settable range data including working environment data that matches the current working environment of the printer, sets a specific printing condition in said printer to a specific setting, refers to said interdependency relationship data to acquire a settable range for another printing condition dependent on said specific printing condition, and stores the settable range as settable range data in said settable range data storage medium;
a printing condition input/output interface that refers to settable range data including environment data that matches the current working environment of the printer to acquire the settable range of said printing condition, and displays on a predetermined output device a decision branch for selecting said printing condition within said settable range as well as handling input of printing condition settings;
a printing condition updater that refers to said settable range data and acquires the settable range of a printing condition dependent on a printing condition changed by input of said setting, and displays on a predetermined output device the settable range of said dependent printing condition;
a print executing instruction handler for handling an instruction to execute printing at printing conditions in said handled settings; and
a print controller for driving a printer at printing conditions in said handled settings in response to an instruction to execute printing, to print an image.

15. Printing control program product for setting by means of a UI printing conditions of a printer connected to a computer as well as controlling the printer under printing conditions set from the UI, said printing control program product comprising:
storing in a predetermined storage medium interdependency relationship data indicating interdependency relationships among said printing conditions;
storing in a predetermined storage medium settable range data indicating settable ranges of said printing conditions, said settable range data including working environment data specifying the working environment of said printer;
a printing condition acquisition function whereby, in the event that there is not recorded in said settable range data storage medium settable range data including working environment data that matches the current working environment of the printer, a specific printing condition in said printer is set to a specific setting, reference is made to said interdependency relationship data to acquire a settable range for another printing condition dependent on said specific printing condition, and this is stored as settable range data in said settable range data storage medium;
a printing condition input/output function whereby reference is made to settable range data including environment data that matches the current working environment of the printer to acquire the settable range of said printing condition, and there is displayed on a predetermined output device a decision branch for selecting said printing condition within said settable range as well as handling input of printing condition settings;
a printing condition update function whereby reference is made to said settable range data to acquire the settable range of a printing condition dependent on a printing condition changed by input of said setting, and there is displayed on a predetermined output device the settable range of said dependent printing condition;
a print executing instruction handling function whereby an instruction to execute printing at printing conditions in said handled settings is handled; and
a print control function whereby a printer is driven at printing conditions in said handled settings in response to an instruction to execute printing, to print an image.

16. Working condition acquisition method for acquiring a settable range of working conditions of a peripheral connected to a computer, said working condition acquisition method comprising:
a working environment change detecting step for detecting change in the working environment of said peripheral; and
a settable range acquiring step wherein if a change in working environment is detected, a settable range of working conditions settable for said peripheral in that working environment is acquired.
